(19) United States
(12) Patent Application Publication
(10) Pub. No.: US 2021/0287285 A1
(43) Pub. Date: Sep. 16, 2021

(54) LIGHTWEIGHT BLOCKCHAIN SUPPORTED TRANSACTION PLATFORM WITH TOKEN INTEGRATED LENDING ENHANCEMENTS

(71) Applicant: Jun Yan, Palo Alto, CA (US)

(72) Inventor: Jun Yan, Palo Alto, CA (US)

(73) Assignee: TraDove, Inc.

(21) Appl. No.: 16/820,661

(22) Filed: Mar. 16, 2020

(51) Int. Cl. G06Q 40/02; G06Q 10/10; G06Q 20/38; G06Q 40/04; G06Q 20/06; G06F 16/27; G06F 16/23

(52) U.S. Cl. CPC G06Q 40/025; G06Q 10/10; G06Q 20/381; H04L 9/0643; G06Q 20/0652; G06F 16/27; G06F 16/2379; G06Q 40/04

(57) ABSTRACT

Systems and methods for providing token-based loan products having fixed and/or quasi-floating interest rates keyed to an elapsed amount of time between issuance of loaned tokens and the time (i) the tokens are returned by the first network participant as repayment, (ii) the loan is paid off by the first network participant in fiat-cash, (iii) the tokens are exchanged for fiat currency by either the first network participant or a direct or indirect payee of the first network participant.

### TECHNICAL FIELD

This disclosure relates to blockchain transaction networks, and more specifically some embodiments disclosed herein relate to a lightweight blockchain supported transaction platform supporting proof-of-two consensus conditioned block modifications, abbreviated transaction ledgers, fiat pegged cryptocurrencies (also called tokens or coins), digital bills, token based loans, blockchain (BC) checking, smart contracts, and centralized identification management.

### BACKGROUND

A blockchain is generally understood to be a distributed database (e.g., a ledger) that can record transactions between parties in a verifiable manner. Conventional blockchain based platforms utilize such a decentralized digital ledger to record all transactions occurring within the network into blocks that are successively linked together using cryptography. Typically, each subsequent block in the chain includes a cryptographic hash of the previous block. In conventional blockchain systems, the entire ledger (including all transactions that have occurred within the network) is distributed to all the nodes in the network. The ledger is said to be immutable and transparent. In conventional systems, the blockchain cannot be altered without first obtaining consensus for the change by a majority of all the nodes in the network, based on traditional consensus protocols.

However, because conventional blockchain supported transaction platforms are all-network transparent, and because copies of the entire ledger (i.e., a ledger of all transactions between any and all participants within the blockchain network) are held by all the nodes in the network without respect to any particular node's participation in a transaction, they cannot meet the privacy requirements often desired in business-to-business transactions. In instances where a business may wish to keep its participation in a specific transaction with another party private from another party (or subset of other parties) on the same blockchain network, conventional blockchains fail. Furthermore, the all-encompassing ledger in conventional designs make the blockchain computationally cumbersome and unsustainable as the number of transactions grows. The sheer volume of anticipated transactions occurring across a given network will cause conventional blockchain supported transaction platforms to become even more bogged-down with the heavy computational workload, and left wanting for the computational power to make speedy and practical use of the platform. What's more, the cryptocurrencies (sometimes referred to herein as “coins”) often provided through conventional blockchain supported transaction platforms are incredibly volatile. Because these cryptocurrencies (e.g., Bitcoin, Ethereum, etc.) are of uncertain value relative to fiat currencies (i.e., not tied to fiat currency at a certain or predictable exchange rate), any presumed value in the cryptocurrency disappear in an instant. Moreover, conventional blockchain supported transaction platforms do not offer advanced and dynamic token based loan products to achieve more competitive offerings than fiat based loan arrangements, nor do they offer advanced and dynamic BC checking.

### SUMMARY

A claimed solution rooted in computer technology overcomes problems specifically arising in the realm of computer technology—namely a double-spend problem in blockchain supported transaction platforms, computationally onerous blockchains, privacy concerns, fiat based loan arrangements lacking dynamic competitive features, fiat based electronic checks and wire transfers, among others. A blockchain network platform is provided with advanced token based loan features and BC check features. The token based loan technology enables a broader range of loan products, and intelligent relationships between lenders and borrowers interacting on such networks. The BC check technology enables a streamlined redemption process that avoids the time and resource consuming “check clearing” process that ensues in traditional checking environments.

Token based loan systems and methods involve generating token based loans in a blockchain supported network, including receiving a loan request from a first network participant, the loan request including an amount of fiat-currency; determining a number of tokens that correspond to the amount of fiat-currency, the determination based on a pre-determined exchange rate of fiat currency to tokens; and offering one or more loan products to the first network participant based on the loan request, the one or more loan products including loan terms comprising a fixed and/or quasi-floating interest rate associated with the number of tokens, wherein the fixed and/or quasi-floating interest rate is an interest rate applicable to one or more of the number of tokens based on an amount of time elapsed between a time the tokens are transferred to the first network participant and the time that: (i) the tokens returned by the first network participant as repayment, and/or (ii) the loan is paid off by the first network participant in fiat-cash, and/or (iii) the tokens exchanged for fiat currency by either the first network participant or a direct or indirect payee of the first network participant; receiving an indication of selection and acceptance of the terms of one of the one or more loan products by the network participant; and/or transferring the determined number of tokens to the first network participant in accordance with the loan product associated with the received indication, without transferring the fiat currency corresponding to the amount of fiat-currency to the first network participant.

In some embodiments, the token based loan systems and methods of the present disclosure may include exchanging, in response to a request from a holder of one or more of the number of tokens, an amount of fiat currency for an amount of the one or more of the number of tokens at the predetermined exchange rate. In some embodiments, the token based loan systems and methods of the present disclosure may include determining the date of the exchange; and/or determining the date upon which a token of the number of tokens was transferred to the first network participant pursuant to the loan product associated with the received indication.

In some embodiments, the token based loan systems and methods of the present disclosure involve determining the quasi-floating interest rate applicable to the exchanged tokens based on the amount of time elapsed between the date of the exchange and the date upon which a token of the number of tokens was transferred to the first network participant. They systems and methods may further involve applying the quasi-floating interest rate to the number of tokens exchanged to determine a first interest accrual amount; and/or applying the first interest accrual amount to a principal amount associated with the loan product associated with the received indication.

In some embodiments the quasi-floating interest rate decreases with increased time elapsed between a time the tokens are transferred to the first network participant and the time that: (i) the tokens returned by the first network participant as repayment, and/or (ii) the loan is paid off by the first network participant in fiat-cash, and/or (iii) the tokens exchanged for fiat currency by either the first network participant or a direct or indirect payee of the first network participant. In some embodiments the quasi-floating interest rate may become a negative interest rate if the time elapsed between a time the tokens are transferred to the first network participant and the time the tokens are exchanged for fiat currency exceeds a predetermined threshold. In some embodiments, the threshold is equivalent to the term of the loan product associated with the received indication. In other embodiments the threshold is greater than the term of the loan product associated with the received indication. In other embodiments the threshold is less than the term of the loan product associated with the received indication.

In some embodiments, the quasi-floating interest rate changes during a term of the loan and/or the quasi-floating interest rate formula/scale changes during a term of the loan based on one or more criteria being met or failing to be met, as defined within the loan product for a particular loan.

BC checking systems and methods involve receiving a BC check request from a first network participant, the BC check request indicating the intended recipient of the BC check and the amount of funds to be redeemable by the intended recipient upon redeeming a BC check generated based on the request; determining whether the digital wallet of the first network participant has access to a sufficient amount of funds to ensure that the recipient network participant's ability to redeem the BC check for fiat currency at a financial institution associated with the first network participant; generating, in response to determining that sufficient funds exist to support issuance of the BC check, the BC check based on the BC check request, wherein the generated BC check is transmittable from one digital wallet to another; transmitting the BC check from a digital wallet associated with the first network participant to a digital wallet associated with the recipient network participant; transmitting the BC check from the digital wallet of the node associated with the recipient network participant to a financial institution associated with the first network participant; and/or transferring, upon request to cash the BC check at the financial institution associated with the first network participant, an amount of fiat currency corresponding to the amount designated by the BC check from the first network participant's account at the financial institution associated with the first network participant to the recipient network participant's account at the financial institution associated with the recipient network participant.

In some embodiments, such systems and methods involve locking, upon generating the BC check, tokens in the first network participant's digital wallet, wherein the amount of tokens locked corresponds to the amount of tokens designated by the BC check. Locking a token may involve restricting the transferability of the token (e.g., until the BC check has been terminated).

In some embodiments, such systems and methods involve determining a time at which the BC check expires; terminating the BC check after the time at which the BC check expires.

In some embodiments, such systems and methods involve transmitting deposit account information of the recipient network recipient to the financial institution associated with the first network participant.

In some embodiments, such systems and methods involve authenticating the first network participant and the recipient network participant without requiring authentication of the first network participant and the recipient network participant by the financial institution associated with the recipient network participant. In some environments, the financial institution associated with the first network participant and the recipient network participant are different financial institutions, where in other environments they may be the same. In some embodiments the financial institution associated with the first network participant is associated with a network node comprising the financial institution's digital wallet. Similarly, the financial institution associated with the recipient network participant is associated with a network node comprising the digital wallet of the financial institution associated with the recipient network participant.

Furthermore, a lightweight blockchain network platform is provided for creating, issuing, and controlling different types of transactions on a blockchain network system. The systems and methods presented herein ensure secure payments between network participants, while saving transactions and their validations only between the transaction participants. Thereby, privacy is obtained by limiting the visibility of the network and validating users through a centralized identity node. For example, a method presented by the present disclosure includes receiving a proposed block of data including a data structure comprising a representation of a transaction completed between a first network participant and a second network participant pursuant to a smart contract in a blockchain supported network; applying a proof-of-two consensus rule to the proposed block of data to obtain a result; obtaining a proof-of-two consensus among the first network participant and the second network participant; and linking, responsive to the obtained consensus, the block of data only onto a respective blockchain of the first network participant and the respective blockchain of a second network participant. In some embodiments, the consensus obtained is not from a majority of user nodes in the blockchain supported network.

Furthermore, the present disclosure provides a system for processing transactions in a blockchain supported network. The system may include one or more processors; and one or more memory devices storing instructions that, when executed by the one or more processors, cause the system to perform operations of: establishing a user node for each of a plurality of network participants, each user node comprising an authenticated ID and a digital wallet, the digital wallet configured to manage tokens acquired by the respective network participant associated with the user node; depositing, in exchange for a received amount of fiat currency and at a predetermined exchange rate, a number of disposable tokens into the digital wallet of the first network participant's user node in exchange for the received amount of fiat currency; providing a smart contract to facilitate a transaction between the first network participant and a second network participant, the smart contract comprising transaction terms, the transaction terms comprising a payment term, the payment term comprising an amount of fiat currency pegged coins; locking, upon receiving a required digital signature (or other forms of authorization) from the first network participant and a required digital signature (or other forms of authorization) from the second network participant, a number of tokens in the digital wallet of the first network participant's user node; releasing, upon receiving an indication of agreement from both the first network participant and the second network participant, the number of tokens from the digital wallet of the first network participant's user node to the digital wallet of the second network participant's user node. In some embodiments, the tokens persist within the system unless they are otherwise burned or expired.

In some embodiments such operations further include receiving a proposed block of data comprising a data structure comprising a representation of the transaction completed between the first network participant and the second network participant pursuant to the smart contract; and/or applying a proof-of-two consensus rule to the proposed block of data to obtain a result.

In some embodiments such operations further include receiving a number of tokens from the second network participant's user node; and/or depositing into an account associated with the second network participant, in exchange for the received amount of tokens from the second network participant's user node and at the predetermined exchange rate, an amount of fiat currency corresponding to the number of disposable tokens received from the second network participant's user node.

In some embodiments, the system is further configured such that the one or more memory devices store instructions that, when executed by the one or more processors, further cause the system to perform operations of: determining if the proposed block of data accurately reflects the occurrence of the transaction completed between the first network participant and the second network participant pursuant to the smart contract.

In some embodiments, the system is further configured such that the one or more memory devices store instructions that, when executed by the one or more processors, further cause the system to perform operations of: receiving, obtaining, and/or identifying an indication of consensus, wherein the indication of consensus signifies that two or more participating network participants applied the same proof-of-two consensus rule to the same proposed block of data and arrived at the same determination. In some instances the determination is that the proposed data block does indeed accurately reflect the occurrence of the transaction completed between the participating network participants (e.g., the first network participant and the second network participant) pursuant to the smart contract. In that event, the instructions may further cause the system to perform the operations of: linking the proposed block of data onto a prior block of data using a hash generated by a hashing algorithm, the hash based at least in part on the prior block of data.

In some embodiments, the system is further configured such that the one or more memory devices store instructions that, when executed by the one or more processors, further cause the system to perform operations of: generating a block of data comprising a data structure comprising a representation of the transaction completed between the first network participant and the second network participant pursuant to the smart contract; and/or applying a hash algorithm to a subset of information, the subset of information comprising a hash value of a previously generated block of data. In some embodiments, the subset of information further includes a transaction parameter of the transaction completed between the first network participant and the second network participant pursuant to the smart contract.

In another example, a method presented by the present disclosure includes: establishing an account for each of a plurality of network participants, each account comprising an authenticated ID and a digital wallet, the digital wallet configured to manage tokens acquired by the respective network participant associated with the account; receiving an amount of fiat currency from a first network participant; depositing, in exchange for the received amount of fiat currency and at a predetermined exchange rate, a number of tokens into the digital wallet of the first network participant in exchange for the received amount of fiat currency; providing a smart contract to facilitate a transaction between the first network participant and a second network participant, the smart contract comprising transaction terms, the transaction terms comprising a payment term, the payment term comprising an amount of currency, wherein the amount of currency is given in one or more of fiat currency units or token units (including, in some embodiments, a symbolic indication of the type of currency, e.g., the “$” symbol for US dollar fiat currency, or any symbol (“[symbol]”) designating a unit of token currency); determining, based on the payment term, a number of disposable tokens to be moved from the first network participant's digital wallet into the second network participant's digital wallet to complete the transaction; locking, upon receiving a required digital signature or other forms of authorization from the first network participant and a required digital signature or other forms of authorization from the second network participant, a number of tokens in the digital wallet of the first network participant, the number of tokens locked being sufficient to satisfy the payment term of the smart contract; releasing, upon receiving an indication of consensus from both the first network participant and the second network participant, a number of disposable tokens sufficient to satisfy the payment term of the smart contract from the digital wallet of the first network participant to the digital wallet of the second network participant; and/or unlocking, upon completion of the release of the tokens to the digital wallet of the second network participant, the tokens in the digital wallet of the second network participant.

In some embodiments, methods of the present disclosure may include receiving a number of tokens from the second network participant; and/or depositing into an account associated with the second network participant, in exchange for the received amount of tokens from the second network participant and at the predetermined exchange rate, an amount of fiat currency corresponding to the number of disposable tokens received from the second network participant.

In some embodiments, methods of the present disclosure may include receiving or creating a proposed block of data comprising a data structure comprising a representation of the transaction completed between the first network participant and the second network participant pursuant to the smart contract; applying a proof-of-two consensus rule to the proposed block of data to obtain a result; and/or determining if the proposed block of data accurately reflects the occurrence of the transaction completed between the first network participant and the second network participant pursuant to the smart contract.

In some embodiments, methods of the present disclosure may include receiving, obtaining, and/or identifying an indication of consensus, wherein the indication of consensus signifies that two or more participating network participants applied the same proof-of-two consensus rule to the same proposed block of data and arrived at the same determination; wherein in some instances the determination is that the proposed data block accurately reflects the occurrence of the transaction completed between the participating network participants (e.g., the first network participant and the second network participant pursuant to the smart contract).

In some embodiments, methods of the present disclosure may further include linking the proposed block of data onto a prior block of data using a hash generated by a hashing algorithm, the hash based at least in part on the prior block of data.

In some embodiments, methods of the present disclosure may include generating a block of data comprising a data structure comprising a representation of the transaction completed between the first network participant and the second network participant pursuant to the smart contract; applying a hash algorithm to a subset of information, the subset of information comprising a hash value of a previously generated block of data; and wherein the subset of information further includes a transaction parameter of the transaction completed between the first network participant and the second network participant pursuant to the smart contract.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates one or more elements of a blockchain network environment in accordance with one or more embodiments of the present disclosure.

FIG. 2 is a diagram illustrating an example architecture of components of a UNode in accordance with one or more embodiments of the present disclosure.

FIG. 3 is a diagram illustrating an example architecture of components of an INode in accordance with one or more embodiments of the present disclosure.

FIG. 4 is an simplified block diagram illustrating an example relationship and process flow that may be implemented to facilitate a transaction between network participants associated with two different UNodes, in accordance with one or more embodiments of the present disclosure.

FIG. 5 illustrates an example data structure representation of the first two blocks in a node-specific blockchain.

FIG. 6 illustrates one or more elements of a blockchain network environment in accordance with one or more embodiments of the present disclosure, and further illustrates a simplified view of the blockchains maintained by individual user nodes within such a blockchain networking environment.

FIG. 7 illustrates an operational flow diagram illustrating an example method that may be implemented to in accordance with one or more embodiments of the present disclosure.

FIG. 8 illustrates an operational flow diagram illustrating an example method that may be implemented to in accordance with one or more embodiments of the present disclosure. (also include down payment and penalty process)

FIG. 9 illustrates an operational flow diagram illustrating an example method that may be implemented to in accordance with one or more embodiments of the present disclosure.

FIG. 10 illustrates a variation on the architecture of components of the example UNode introduced in FIG. 2, shown equipped with a digital bill component, a token based loan component, and a BC check component in accordance with one or more embodiments of the present disclosure.

FIG. 11 illustrates an operational flow diagram illustrating an example method 1100 that may be implemented to in accordance with one or more embodiments of the present disclosure.

FIG. 12 illustrates an operational flow diagram illustrating an example method 1200 that may be implemented to in accordance with one or more embodiments of the present disclosure.

FIG. 13 illustrates process flow illustrating an example method that may be implemented to in accordance with one or more embodiments of the present disclosure.

FIG. 14 illustrates an operational flow diagram illustrating an example method 1400 that may be implemented to in accordance with one or more embodiments of the present disclosure.

FIG. 15 is an example computing device that may be used to implement various features of embodiments described in the present disclosure.

The figures are not exhaustive and do not limit the present disclosure to the precise form disclosed.

### DETAILED DESCRIPTION

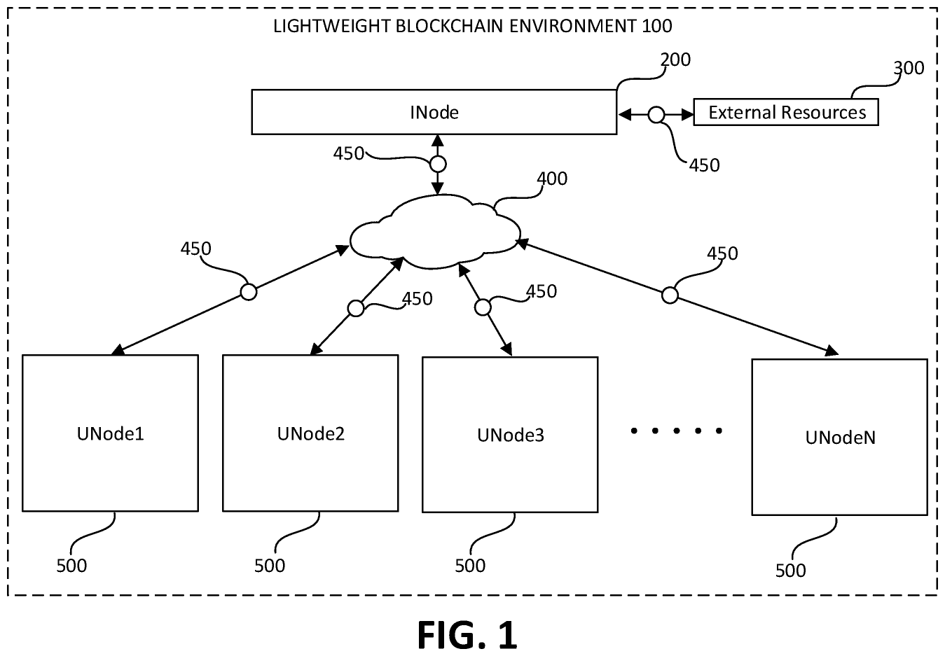

FIG. 1 is a diagram illustrating an example blockchain networking environment in which one or more embodiments of the present disclosure may be implemented. Blockchain networking environment 100 may include a plurality of nodes in communication with one another over network 400 via communication links 450. A “node” refers to any device that participates in a blockchain network. A node can comprise or be coupled with any active electronic device, such as, by way of example, laptop or desktop computers, smartphones, servers, tablets, netbooks, or even printers and other simple electronic devices. Nodes are coupled to or equipped with wired or wireless communication components allowing them to connect to and communicate with other Nodes over network 400, such as, by way of example, communication with other nodes over network 400 (e.g., over the Internet using an Ethernet, Wi-Fi, or Cellular connection, for example).

As shown, the nodes of blockchain networking environment 100 include multiple user nodes, UNode1, UNode2, . . . UNodeN communicatively coupled with one or more identity nodes, INode 200, the INode being further communicatively coupled with one or more external resources 300.

An INode (i.e., an “identity node”) is a node that is associated with a centralized identity verification and account management entity (e.g., TraDove), and a UNode (i.e., an “user node”) is a node that is associated with a network participant (e.g., a business, an organization, an institution, a person, an entity, or other user). For example, INode 200 may be embodied in one or more computer systems associated with a financial institution (e.g., a bank), and each UNode 500 may be embodied in one or more computer systems associated with a potential transactor on the network (e.g., potential buyers and potential sellers).

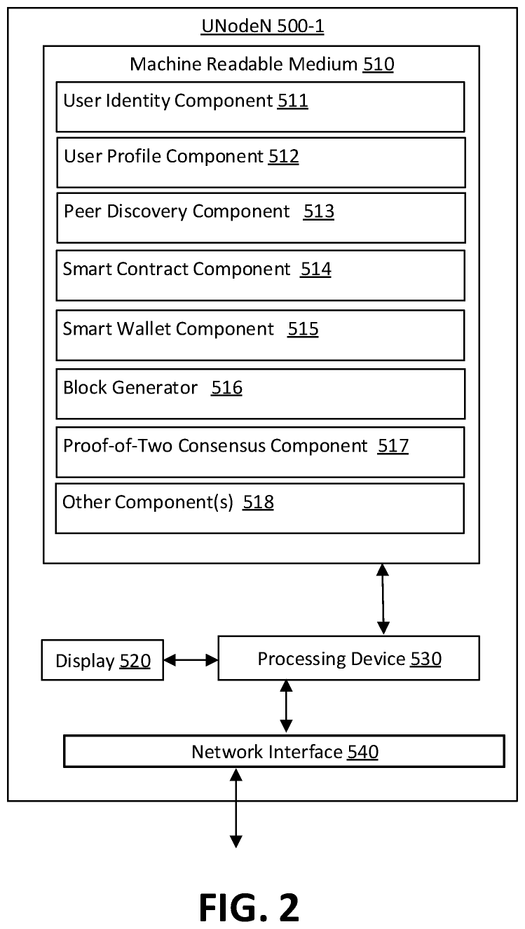

A UNode is configured to support the blockchain network embodiments of the present disclosure by maintaining a node-specific copy or partial copy of a blockchain (e.g., a copy of a blockchain that corresponds only to the transactions made by and with the network participant associated with that UNode). As described further with reference to FIGS. 2-10, a UNode is configured to check new transactions to be added to its blockchain using a novel Proof-Of-Two consensus protocol in accordance with one or more embodiments of the present disclosure. In some instances, a UNode can be configured to process transactions. Individual UNodes 500 may be embodied in one or more computer systems associated with individual network participants, where network participants are entities registered with blockchain network 100, and who may, upon satisfying requirements, participate in transactions with other network participants on a transaction platform supported by the blockchain network 100. In connection with the technology presented by the present disclosure, respective roles and functionality of the INode 200 and individual UNodes 500 in the blockchain network are discussed in further detail with respect to FIGS. 2-10.

Individual UNodes 500 may be embodied in computer systems associated with individual network participants, where network participants are entities registered with blockchain network 100, and who may, upon satisfying requirements, participate in transactions with other network participants on a transaction platform supported by the blockchain network 100.

Communication links 450 may connect nodes and/or other resources within blockchain networking environment 100 to network 400, and thereby to each other. Communication links 450 may be dynamically reconfigurable such that new nodes and/or other resources may be connected to or removed from the blockchain networking environment 100 as the network evolves with new and/or different participants, and new and/or different resources. Communication links 450 may include any type of link. For example, one or more links 450 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), optical (such as for example Synchronous Optical Network (SONET) or Synchronous Digital Hierarchy (SDH)) links, or any one or more of an ad hoc network, an intranet, an extranet, a VPN, a LAN, a WLAN, a WAN, a WWAN, a MAN, a portion of the Internet, a portion of the PSTN, a cellular technology-based network link, a satellite communications technology-based network link, another link 450, or a combination of two or more such links 450. Links 450 need not be the same throughout blockchain networking environment 100. Indeed, one or more first links 450 may differ in one or more respects from one or more second links 450. Communication over links 450 may include any request to send or receive any type of information accessible within blockchain networking environment 100.

Network 400 may include any type of communication network. As an example and not by way of limitation, one or more portions of network 400 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these.

In connection with the technology presented by the present disclosure, respective roles and functionality of INode 200 and individual UNodes 500 in the blockchain network will discussed in further detail below with respect to FIGS. 2-10.

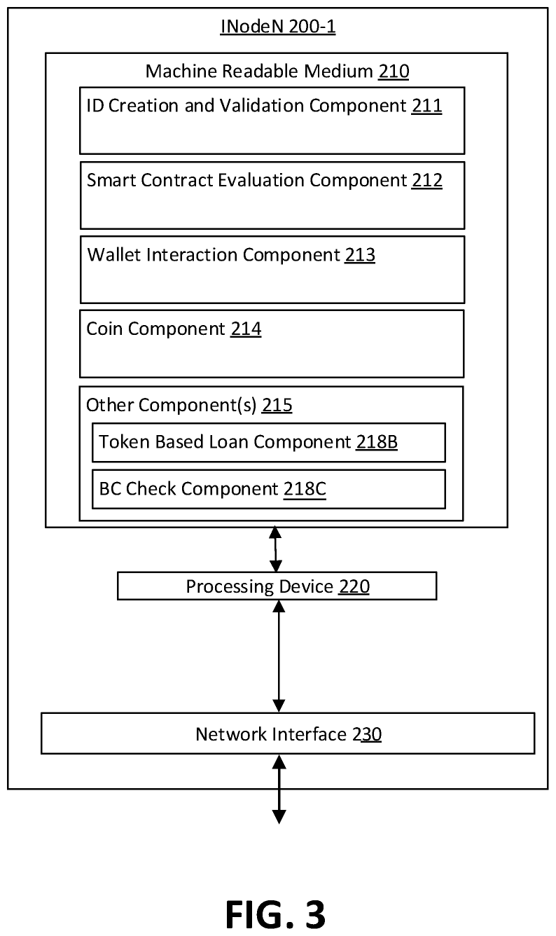

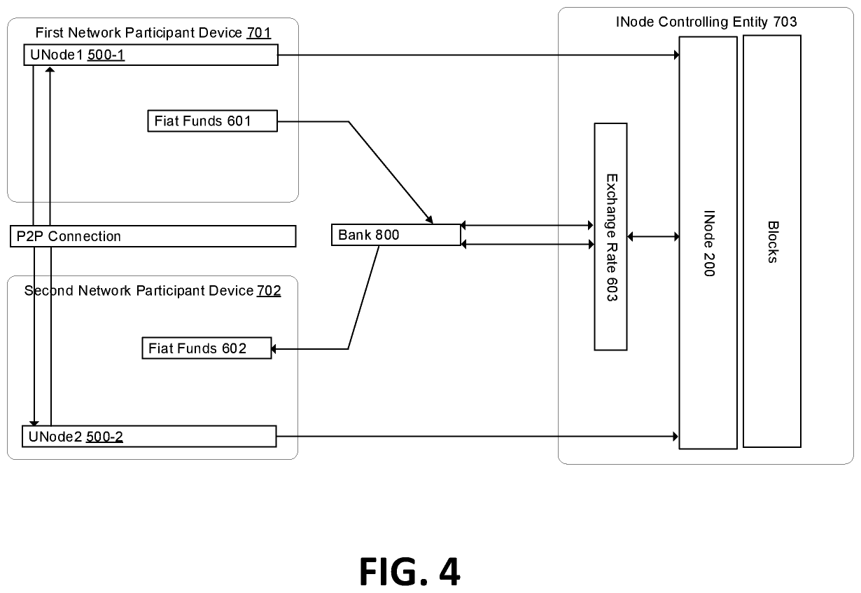

FIG. 2 is a diagram illustrating an example architecture of components of an example UNode 500-1, in accordance with one or more embodiments of the present disclosure. FIG. 3 is a diagram illustrating an example architecture of components of an example INode 200-1, in accordance with one or more embodiments of the present disclosure. Each component of the example UNode and example INode will be introduced here with reference to FIGS. 2-3, followed by additional features and context provided in examples discussed with reference to FIGS. 4-6.

Referring now to FIG. 2, UNodeN 500-1 may include a machine readable medium 510 having instructions stored thereon, which, when executed by one or more processors, cause one or more of the disclosed features to be effectuated. The machine readable medium may have machine readable code comprising a User Identity Component 511, User Profile Component 512, Peer Discovery Component 513, Smart Contract Component 514, Smart Wallet Component 515, Proof-of-Two Consensus Component 517, Block Generator 516, and one or more other components 518 configured to offer a number of additional features, enhancements, and functionally.

User Identity Component 511 acquires, stores, encrypts, and/or maintains identifying information associated with the particular network participant associated with the particular UNode. Such identifying information may include any static or dynamic information that, considered alone or taken together, is unique to a network participant among the plurality of network participants. By way of example, such identifying information may include (i) a unique user ID and/or password created during the network participant's registration with blockchain networking environment 100, (ii) a unique user ID and/or password associated with another service or platform that network participant subscribes to or maintains a membership with (e.g., LinkedIn, Instagram, Facebook, Gmail, Outlook, ABC Bank) and/or has concurrently (or within a predetermined period of time) accessed on the same computing device hosting the UNode, (iii) a serial number or electronic ID of the computing device hosting the UNode, (iv) real-time or previously measured digital fingerprint information, retinal scan information, face recognition, or other biometric information, (v) sensed information accessible to or through the computing device hosting the UNode associated with the network participant (e.g., GPS location information, temperature information, biometric information, audio/voice information, etc.), (vi) selected security questions and/or answers thereto, (vii) images, videos or other multimedia, (viii) a social security number, a date of birth, a government issued ID number (e.g., drivers license number, TaxID number), (ix) revenue information associated with the network participant, or anything else desired in the context of a transaction. One of skill in the art will appreciate that many other forms of identifying information may be acquired, stored, encrypted, and/or maintained by User Identity Component 511.

User Identity Component 511 may further create a unique hash identifier (“referred to herein as a NodeIDAddress) for the user that is based upon one or more pieces of such identifying information as an input to a hashing algorithm, or a unit of information assigned to the new network participant by the INode 200. During a network participant's initial registration with the blockchain network 100, INode 200 may create and digitally sign an initial entry and create a genesis block for the particular UNode 500 chain that is based, in whole or in part, on the NodeIDAddress. The signing of the initial entry by the INode 200 (e.g., using a cryptographic key) allows only the INode 200 to create and/or approve a genesis block within a new network participant's node-specificspecific blockchain. In some instances the unique identifier may be assigned or provided as part of the node's participation in a blockchain transaction.

User Profile Component 512 receives input from a network participant (or an authorized representative of the network participant) regarding the appearance and content of a profile that may be searchable and viewable by peer network participants also registered to transact within blockchain networking environment 100. User Profile Component 512 may generate and/or make available for display, alone or in coordination with other resources within blockchain networking environment 100 (e.g., a server supporting INode 200), a digital profile that is searchable and/or viewable by peer network participants within the blockchain networking environment 100 (e.g., by searching a blockchain network participant database from an interface displayed through a display of a computing device hosting another UNode 500-1). User Profile Component 512 may also receive input or feedback from a peer networking participant in connection with the generated user profile. Such input or feedback may be provided for display on the network participant's user profile such that other peer networking participants can observe the input or feedback when viewing the network participants user profile. For example, input or feedback from a peer networking participant may include a rating concerning a prior transaction experience, a recommendation based on other information, a review, etc.). User Profile Component 512 may further monitor the network participant's activities (e.g., transactions) over the Network 400 (shown in FIG. 1), and generate, store, and/or make available for display information relating to such activities (e.g., transaction statistics, etc.).

Peer Discovery Component 513 provides, alone or in coordination with other resources within blockchain networking environment 100 (e.g., a server supporting INode 200), a search engine allowing a first network participant to search and view the User Profiles of other peer network participants who may be open to transacting business with the first network participant within the blockchain networking environment 100.

Smart Contract Component 514 may receive, create, and/or provide, alone or in coordination with other resources within blockchain networking environment 100 (e.g., a blockchain supported transaction platform running on a server supporting INode 200), a smart contract that can be shared with, digitally edited by, collaborated upon, and agreed to by multiple network participants. Smart Contract Component 514 may provide for display on an interface a user-friendly and human readable version of the smart contract, which may further include one or more fields and/or buttons for editing, modifying, accepting, rejecting, agreeing and/or digitally signing one or more provisions of a draft smart contract, and/or for providing a final approval for the automated execution of the smart contract once each network participant who is a party to the smart contract has satisfied all of the necessary terms. It will be appreciated that a “smart contract” as used herein comprises self-executing code residing on a blockchain network (e.g., on INode 200, one or more UNodes 500, or other blockchain network resource, or a combination of the foregoing), which, when executed effectuates completion of the associated transaction (e.g., it automatically executes a payment and/or delivery term of the contract) between trusted UNodes based on events that took place in connection with a blockchain supported transaction platform.

Smart Wallet Component 515 maintains and secures, alone or in coordination with other resources within blockchain networking environment 100 (e.g., a server supporting INode 200), a digital wallet owned by the network participant and associated with the given UNode. The digital wallet may include a network participants cryptocurrency holdings (which may, in some instances, have been sourced from token based loans), BC checks, blockchain network accounts, and private/public keys associated therewith. Smart Wallet Component 515 can be configured to provide management functionality, alone or in coordination with other resources within blockchain networking environment 100, such as transferring, converting, sending, receiving, releasing, exchanging, depositing, withdrawing, moving, securing or otherwise operating on cryptocurrency funds and/or fiat funds upon request. Smart Wallet Component 515 may further be configured to execute code to lock cryptocurrency coins, or allow a digitally signed smart contract to lock coins, in an amount sufficient to support the transaction described in the smart contract, etc. In some embodiments, Smart Wallet Component 515 may further be configured to execute code that causes the system to refund, release, receive, transfer, send, lock an amount of cryptocurrency to another network participant. In some embodiments, Smart Wallet Component 515 may further be configured to execute code to provide balance reporting after one or more transactions has occurred involving currency managed by the given Smart Wallet of a network participating, which may be accessible or viewable via a user device or other device within the blockchain networking environment. In some embodiments, Smart Wallet Component 515 may further be configured to facilitate back-up (e.g., periodic back-up, on demand back-up, or one-time back-up) for later restoration by a given network participant as needed (e.g., if the given network loses their digital wallet (e.g., loses their UNode device such as their smart phone)).

Block Generator 516 applies a hashing algorithm to an input to generate a proposed next block (a data structure shown in FIG. 3) for addition onto the blockchain. The input to the hashing algorithm includes the information from the most recently added block in the blockchain (including its cryptographic key), as well as the information for the one or more transactions that are claimed to have occurred after the most recent block was added to the chain. In some instances, the most recent block in the chain will be a genesis block (e.g., for new network participants). Blocks generated by Block Generator 516 will be added to the UNode 500-1's blockchain if consensus is reached pursuant to a Proof-of-Two Consensus protocol.

Proof-of-Two Consensus Component 517 (also referred to herein as “Po2” Consensus Component 517) comprises a predetermined consensus protocol which, when executed by a processor of the computing system hosting UNode 500-1, applies Po2 consensus rules to determine whether or not the transaction(s) represented by a proposed block actually occurred as represented. For example, when a block is proposed for addition to the blockchain, and the block includes one or more records of transactions claimed to have been executed in accordance with one or more smart contract of the present disclosure, the Po2 Consensus Component 517 at each UNode that was a party to the underlying transactions will apply the Po2 consensus rules to the proposed block to decide whether or not the underlying transactions represented by the proposed block are true/valid (i.e., that each UNode that was a party to the underlying transaction(s) sent and received what each intended to send and receive pursuant to the smart contract). Upon receiving unanimous acceptance/validation between the two UNode's associated with a two-party transaction, the Po2 consensus rules satisfied and the proposed block may be added to each participating UNode 500's blockchain. As such, the only blocks added to a particular UNode's blockchain are those that include transactions to which the particular UNode 500 was a party. Thereby, the version of the blockchain maintained by each UNode 500 is lightweight in that it involves far fewer and less complex blocks (on account of far fewer transactions), and fewer nodes executing less computationally intensive algorithms to arrive at a consensus before a block is added to a chain.

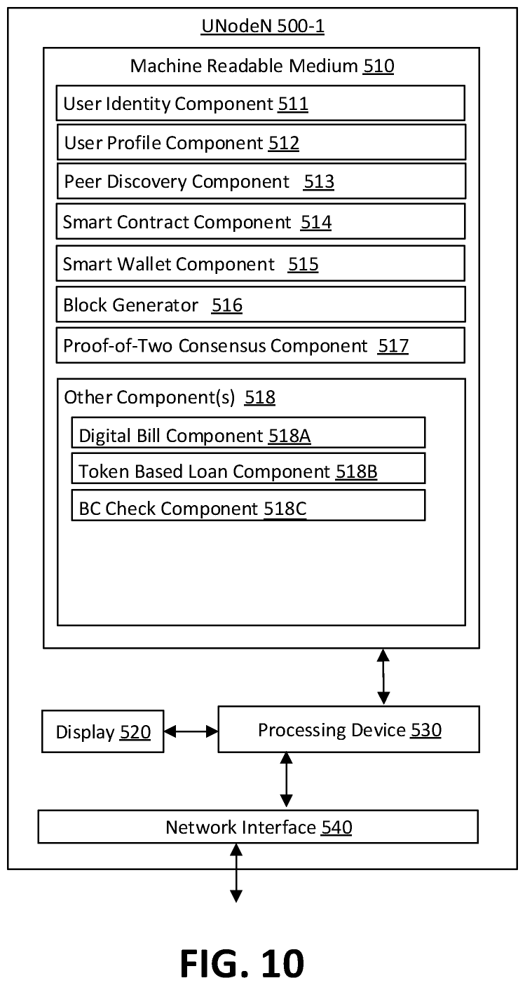

Other components 518 may include a number of other components 518, some of which are discussed further with respect to FIG. 10.

As further shown in FIG. 2, UNodeN 500-1 may be comprise or otherwise be operatively coupled with a display 520, a processing device 530, and a network interface 540. Display 520 may be any digital display that displays visual information based on instructions executed by a processor connected thereto. For example, display 520 may include touchscreen displays, computer monitor displays, television displays, etc. Processing device 530 may include one or more processors that performs processing operations or a combination of specialized and/or general-purpose processors that perform processing operations. For example, processing device 530 may include a CPU, GPU, APU, DSP, FPGA, ASIC, SOC, and/or other processing circuitry. Network interface 540 may be any communication circuit configured for communicating over a wired or wireless network. Network interface 540 provides a two-way data communication through network 400 over one or more communication links 450 (FIG. 1). For example, network interface 540 may be an integrated services digital network (ISDN) card, cable modem, satellite modem, a cellular chipset, or a modem to provide a data communication connection to a corresponding type of communication line. As another example, network interface 540 may be a local area network (LAN) card to provide a data communication connection to a compatible LAN (or WAN component to communicated with a WAN). Network interface 540 may send and receive electrical, electromagnetic, optical or other signals that carry digital data streams representing various types of information. It will be appreciated that one or more of display 520, processing device 530, and network interface 540 may be embodied in any type of computing device (e.g., a smartphone).

Referring now to FIG. 3, INode 200-1 may include a machine readable medium 210 having instructions stored thereon, which, when executed by one or more processors, cause one or more of the disclosed features to be effectuated. The machine readable medium may have machine readable code comprising a ID Creation and Validation Component 211, a Smart Contract Evaluation Component 212, a Wallet Interaction Component 213, a Coin Component 214, and/or one or more Other Component(s) 215.

ID Creation and Validation Component 211 receives information from prospective network participants, and if approved, registers a UNode into the blockchain networking environment that is associated with the approved prospective network participant, and a corresponding NodeIDAddress. For example, using a network participant's initial registration with the blockchain network 100, INode 200 may create and digitally sign an initial entry and create a genesis block for the particular UNode 500 chain that is based, in whole or in part, on the NodeIDAddress. The signing of the initial entry by the INode 200 (e.g., using a cryptographic key) allows only the INode 200 to create and/or approve a genesis block within a new network participant's node-specific blockchain. Further, whenever a registered UNode 500 requests to provide any input into the blockchain networking environment (e.g., a request to interact with another network participant in connection with a potential smart contract supported transaction, a request to modify or provide feedback concerning a user profile, etc.), ID Creation and Validation Component 211 may authenticate and/or validate the participant in any manner desired for the context of the request, for example, by using a single sign-on authentication, two-factor authentication, biometric authentication, active directory authentication, certificate-based authentication, NodeIDAddress authentication, or any other type of authentication of a centralized identity of the network participant. In some embodiments, authentication and/or validation procedures are facilitated only when a UNode user attempts to login to the network, but not for each and every transaction that a UNode participates in over the network after login. In some embodiments, authentication and/or validation procedures are facilitated on a per-transaction basis (e.g., authentication and/or validation procedures occurring each time a UNode attempts to participate in a transaction). Authentication may be performed in response to receiving input (e.g., credentials) from a computing device associated with a UNode 500 in the blockchain networking environment 100.

Smart Contract Evaluation Component 212 receives information about one or more terms in a smart contract that has been accepted and digitally signed by the parties, and if necessary instructs Wallet Interaction Component 213 to take an action, alone or in coordination with a given UNode's Smart Wallet Component 515. In some embodiments the one or more terms includes a payment term, and the action includes locking a number of coins in a UNode 500's digital wallet in an amount sufficient for the transaction underlying the smart contract to be completed. Locking coins may involve placing a restriction on the use, transferability, or representation of a coin such that it may only be used for a single, preapproved purpose.

Wallet Interaction Component 213 receives instructions from Smart Contract Evaluation Component concerning actions to be taken with respect to a digital wallet of a UNode 500 within the blockchain networking environment. Wallet Interaction Component 213 may receive and effectuate any action with respect to a UNode's digital wallet, including by way of example, locking coins, effectuating a release or transfer of coins from one digital wallet to another digital wallet, effectuating an exchange of coins for cash, effectuating deposits, withdrawals, and so on.

Coin Component 214 is configured to exchange fiat currency for cryptocurrency, minting new coins as needed, and burning previously used coins as necessary. For example, a network participant associated with a UNode 500 may wish to wire cash (fiat currency) into an INode 200 controlled account in exchange for the INode 200 minting and depositing a number of coins into an account in the digital wallet of the given UNode 500 (at a predetermined rate of exchange, e.g., 1 coin deposited for each $1 USD wired). Alternatively, a network participant associated with a UNode 500 may wish to receive a cash wire (of fiat currency) from an INode 200 controlled account in exchange for releasing to the INode 200 a number of coins that the UNode 500 has acquired and secured in their digital wallet (again, at the predetermined rate of exchange, e.g., 1 coin deposited for each $1 USD wired). Coin Component 214 facilitates this exchange, alone or in connection with Wallet Interaction Component 213 of INode 200 and Smart Wallet Component 515 of a UNode 500.

Coin Component 214 may receive fiat funds from third party institutions associated with network participants. For example, a network participant may have a bank account with ABC Bank, and instruct ABC Bank to wire $100 to an account and routing number associated with an entity in control of UNode1 500-1. Upon receipt of the $100 wire, UNode1 200 may, via one or more of its Coin Component 214 and Wallet Interaction Component 213, mint and/or deposit 100 coins into the digital wallet of UNode1 500-1.

Other Component(s) 215 of INode 200 may be configured to implement various other features desirable in the given environment. For example, in some contexts it will be desirable for the INode to communicate to relevant UNodes various updates concerning completion of a transaction or other metrics associated with a given transaction. For example, INode 200 may communicate and/or facilitate updates to the token or fiat balances pursuant to the completed transaction, or communicate and/or facilitate transaction statistics for/to each UNode 500 that participated in a particular transaction. In some embodiments, Other Component(s) 215 may be configured to facilitate the sale of tokens held or otherwise owned by the INode 200 controlling entity (e.g., TraDove) in addition or as an alternative to minting new tokens.

FIG. 4 is an simplified block diagram illustrating an example relationship and process flow that may be implemented to facilitate a transaction between network participants associated with two different UNodes, in accordance with one or more embodiments of the present disclosure. This figure will be described, in part, with reference to an example transaction. It will be appreciated, however, that the example is provided merely for descriptive purposes, and in no way limits the technology claimed or described in the present disclosure.

As shown in FIG. 4, UNode1 500-1 is deployed on a first network participant's Device 701, and UNode2 500-2 is deployed on a second network participant's Device 702. Devices 701 and 702 may be smartphone devices, for example, and all of the UNode features described herein may be controlled via a mobile application running on each Device 701 and 702. Running complementary mobile applications for the blockchain network, UNode1 500-1 and UNode2 500-2 may be in communication over a P2P connection (such P2P connections may be established based on the participation of the INode 200 in connection with one or more UNodes 500) Exchanging information through their respective Smart Contract Components (e.g., Smart Contract Component 514-1 (not shown) of UNode1 500-1, and Smart Contract Component 514-2 (not shown) of UNode2 500-2, the smart contract components of each including features discussed herein with respect to Smart Contract Component 514 introduced in FIG. 2)), first network participant and second network participant may arrive at a proposed agreement that is acceptable by both participants, and involves a payment, e.g., of $5000 USD (equivalent to 5000 Coins) from the first network participant to the second network participant.

Upon determining that the proposed smart contract will involve payment valued at $5000USD from the first network participant to the second network participant, Smart Contract Component 514-1 of UNode 500-1 will attempt to lock 5000 coins in UNode1 500-1's digital wallet such that, when given final approval from the parties (e.g., terms are met and both parties clicking an “agree” button), UNode2 500-2's receipt of payment from UNode1 500-1 will be guaranteed. That is, once the terms are met and both network participants provide an indication of final agreement, the smart contract component 514 of the buyer side network participant will release the agreed upon number of buyer's coins into the digital wallet of the seller, for example If there is an inadequate number of coins in UNode1 500-1's digital wallet, the smart contract term will not be met and consequently the smart contract will not be able to be approved until additional tokens are loaded into UNode1 500-1's digital wallet. In the event that, for example, the first network participant owns no coins/tokens, the first network participant must fund its digital wallet with all 5000 Coins. To do so, the first network participant may wire $5000 USD to INode 200 controlled by INode Controlling Entity 703 (e.g., TraDove), where an Exchange Rate 603 has been established such that $1USD=1 Coin, and vice versa. Upon receipt of the first network participant's $5000 USD, INode 200 will mint and/or release 5000 Coins to the digital wallet of the first network participant, held within UNode1 500-1. Upon UNode1 500-1's digital wallet reflecting a balance of 5000 coins, the Smart Contract Component 514-1 of UNode1 500-1 will then lock the coins such that they cannot be used by UNode1 500-1, except for the purpose of satisfying payment obligations under the smart contract. Upon receiving a final approval for execution of the smart contract from both of UNode1 500-1 and UNode2 500-2, UNode 500-11 will release the 5000 coins from UNode1 500-1's digital wallet into UNode2 500-2's digital wallet. Upon UNode2 500-2's receipt of the 5000 coins from UNode1 500-1, UNode2 500-2 may request an exchange of the coins for cash with INode 200 at the established Exchange Rate 603. Upon receiving 5000 tokens from UNode1 500-1 and the completion of the transaction one or both of UNode1 500-1 and UNode2 500-12 may update INode 200 of their token balance and/or other information related to the transaction, including depersonalized information. For example, one or both of UNode 1 and UNode 2 may update INode 200 of transactions statistics such as amounts moved, countries from where the participants were participating, industries involved in or represented by in the transaction, etc.

UNode1 500-1 and/or UNode2 500-2 may utilize their respective Block Generator Components (e.g., Block Generator Component 516-1 (not shown) of UNode1 500-1, and Block Generator Component 516-2 (not shown) of UNode2 500-2, the Block Generator Components of each including features discussed herein with respect to Block Generator Component 516 introduced in FIG. 2) to write one or more new blocks of data structure for proposed entry into their respective node-specific blockchains. Although for descriptive brevity in various examples herein, a single block may represent a single transaction, it will be appreciated that block generator components of the present disclosure may in some implementations generate multiple blocks representing various facets of a single transaction. For example, block generator component 516 of a given UNode 500 may generate three blocks representing a finalized transaction, where one block is generated in connection with creation of the proposed transaction, one block is generated in connection with confirmation/agreement among the participants that the transaction can go forward as agreed, and one block is generated in connection with the settlement/completion of the payment agreed to for the transaction. Each may utilize its Po2 Consensus Component 517-1, 517-2 to decide whether or not the underlying transactions represented by the proposed block are true/valid (i.e., that each UNode that was a party to the underlying transaction sent and received what each intended to send and receive pursuant to the smart contract). Both parties may approve the new blocks of the other, and consensus may be reached pursuant to the Po2 consensus protocol. For example, the first network participant (e.g., buyer) may generate a first block representing the transaction and the second network participant (e.g., seller) may approve the block; next, the second network participant (e.g., seller) may generate a second block representing its approval, and the first network participant (e.g., buyer) approves it; next, the first network participant (e.g., buyer) may generate a third block representing the settlement/payment made, and the second network participant (e.g., seller) confirms it.

Once Po2 consensus is reached among the two network participants that were parties to the smart contract, the proposed blocks are added to the respective node-specific blockchains of each of UNode1 500-1 and UNode2 500-2.

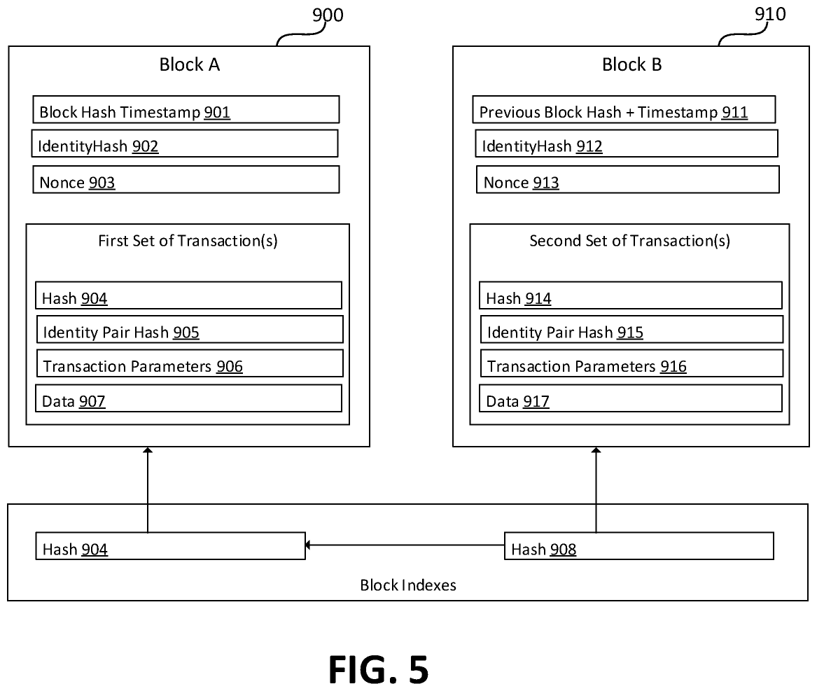

FIG. 5 illustrates an example data structure representation of the first two blocks in a node-specific blockchain. In this example, the blockchain shown is representative of the first two blocks in UNode1 500-1's blockchain. The blocks are generated at the UNode itself (e.g., by the UNode's Block Generator Component), as described herein.

As shown, a BlockA 900 (i.e., the genesis block) comprises information that is only peripherally related to the underlying transaction(s) itself/themselves, combined with information that is directly related to the underlying transaction itself.

The information that is only peripherally related to the underlying transaction(s) includes Block Hash Timestamp 901 (e.g., a hash value where part of the input to the hashing algorithm is a time associated with the block creation), an Identity Hash 902 (e.g., a hash value where part of the input to the hashing algorithm is one or more unique identifiers associated with the network participant, a Nonce 903 (e.g., an arbitrary number that can be used just once, such as a random or pseudo-random number).

The information that is directly related to the underlying transaction(s) include the Identity Pair Hash 905 (e.g., a hash value where part of the input to the hashing algorithm is a combination of the unique identifiers for both network participants who were parties to the transaction), Transaction Parameters 906 (e.g., details relating to the occurrence of the transaction, such as amounts paid, between whom, when paid, etc.), and other Data 907 (any other data that might be relevant to the transaction, and desired to be included in the block). The Hash 904 of a combination of each of the foregoing is included in the data structure of BlockA 900, and serves as the chain that links BlockA 900 with BlockB 910.

As further shown, the data structure of BlockB 910 includes hash values resulting from a combination of the previous block (BlockA) combined with the information directly related to a new transaction or set of transactions. In particular, the data structure of BlockB 910 includes the previous Block Hash 904 in combination with the new Block Has Timestamp 911 (e.g., a hash value where part of the input to the hashing algorithm is a time associated with the prior block's hash, plus the hash of the timestamp for the new block), an Identity Hash 912 (e.g., a hash value where part of the input to the hashing algorithm is one or more unique identifiers associated with the network participant, a Nonce 913 (e.g., an arbitrary number that can be used just once, such as a random or pseudo-random number).

The data structure of BlockB 910 further includes Identity Pair Hash 915 (e.g., a hash value where part of the input to the hashing algorithm is a combination of the unique identifiers for both network participants who were parties to the transaction), Transaction Parameters 916 (e.g., details relating to the occurrence of the transaction, such as amounts paid, between whom, when paid, etc.), and other Data 917 (any other data that might be relevant to the transaction, and desired to be included in the block). The Hash 914 of a combination of each of the foregoing is included in the data structure of BlockB 910, which will serve as a chain segment that links BlockB 910 with the subsequent block.

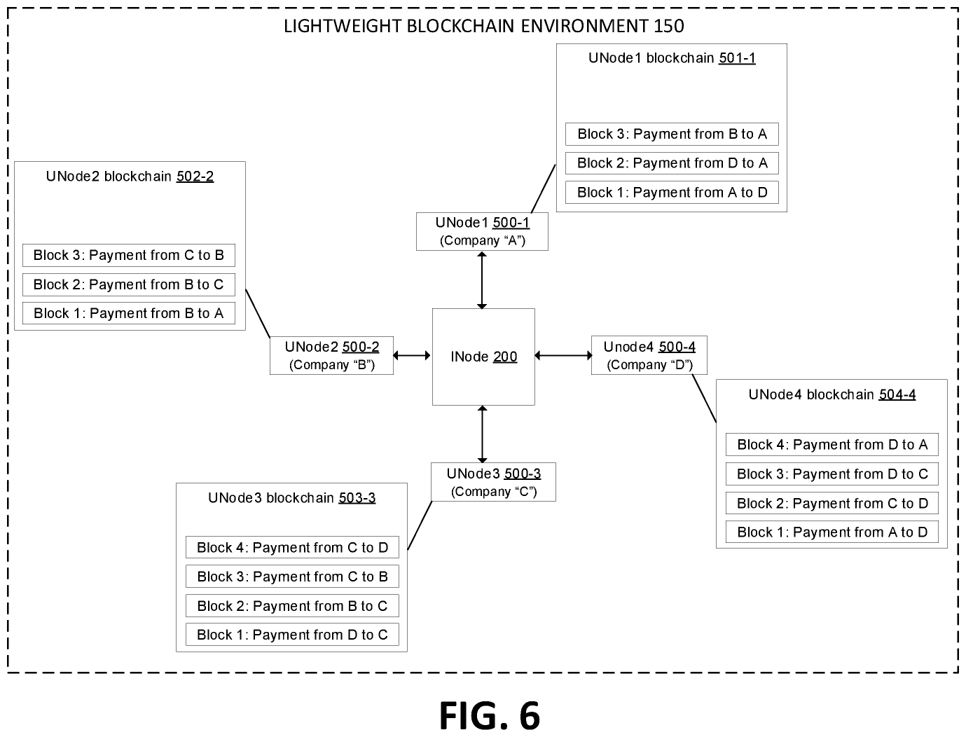

FIG. 6 illustrates one or more elements of a blockchain network environment in accordance with one or more embodiments of the present disclosure, and further illustrates a simplified view of the blockchains maintained by individual user nodes within such a blockchain networking environment. As shown, INode 200 is communicatively connected to four network participants UNode1 500-1, UNode2 500-2, UNode3 500-3, UNode4 500-4 who have transacted with one another multiple times within the blockchain network environment 150. As shown, each of UNode1 500-1, UNode2 500-2, UNode3 500-3, and UNode4 500-4 maintain respective blockchains (which main also be considered ledgers) distributed amongst themselves UNode1 Blockchain 501-1, UNode2 Blockchain 502-2, UNode3 Blockchain 503-3, and UNode4 Blockchain 504-4. As shown, the blocks in UNode1 Blockchain 501-1 only include transactions where the network participant associated with UNode1 500-1 (Company A) was a party to the transaction; the blocks in UNode2 Blockchain 502-2 only include transactions where the network participant associated with UNode2 500-2 (Company B) was a party to the transaction; the blocks in UNode3 Blockchain 503-3 only include transactions where the network participant associated with UNode3 500-3 (Company C) was a party to the transaction; the blocks in UNode4 Blockchain 504-4 only include transactions where the network participant associated with UNode4 500-4 (Company D) was a party to the transaction. INode 200 provides centralized identity management for each of network participants associated with UNode1 500-1, UNode2 500-2, UNode3 500-3, and UNode4 500-4 and may further provide updates of balances and transaction statistics of UNode 500-1, 2, 3, 4, etc. after each transaction or on a periodic basis

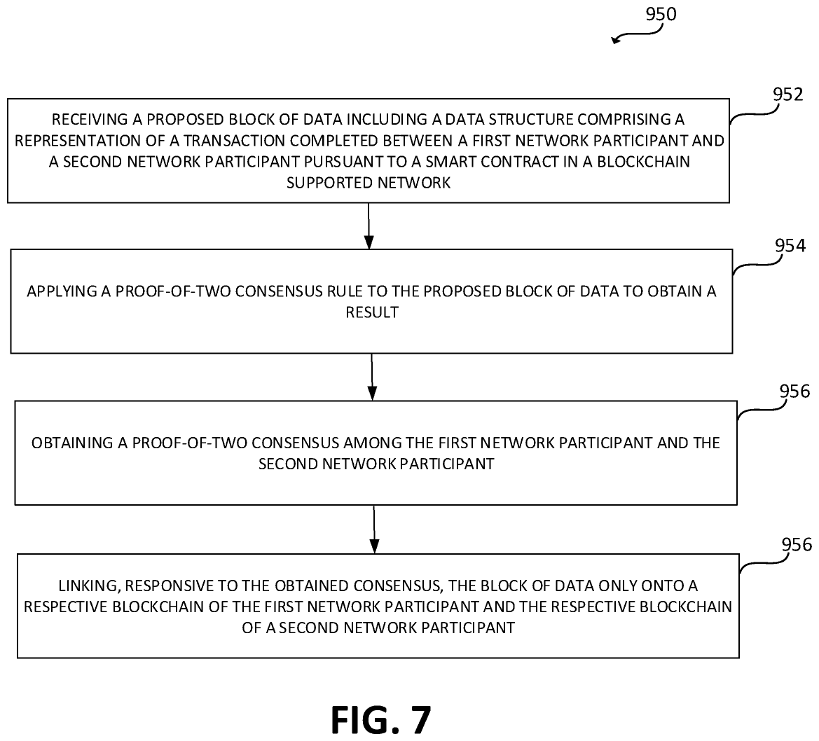

FIG. 7 illustrates an operational flow diagram illustrating an example method 950 that may be implemented to in accordance with one or more embodiments of the present disclosure. At operation 952, method 950 includes receiving a proposed block of data including a data structure comprising a representation of a transaction completed between a first network participant and a second network participant pursuant to a smart contract in a blockchain supported network. At operation 954, method 950 includes applying a proof-of-two consensus rule to the proposed block of data to obtain a result. At operation 956, method 950 includes obtaining a proof-of-two consensus among the first network participant and the second network participant. At operation 956, method 950 includes linking, responsive to the obtained consensus, the block of data only onto a respective blockchain of the first network participant and the respective blockchain of a second network participant.

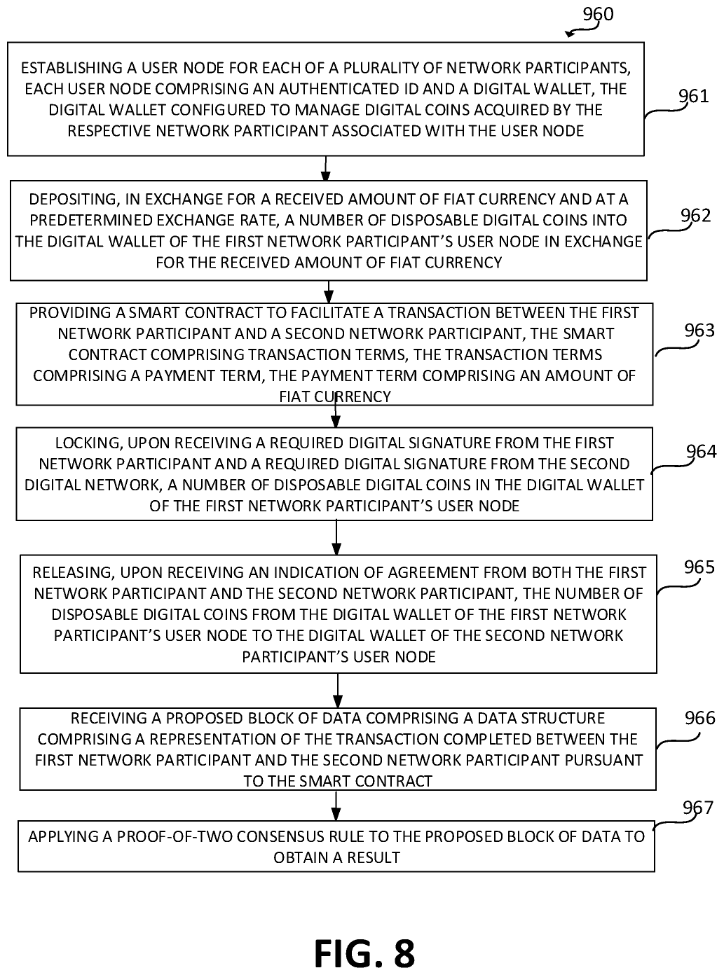

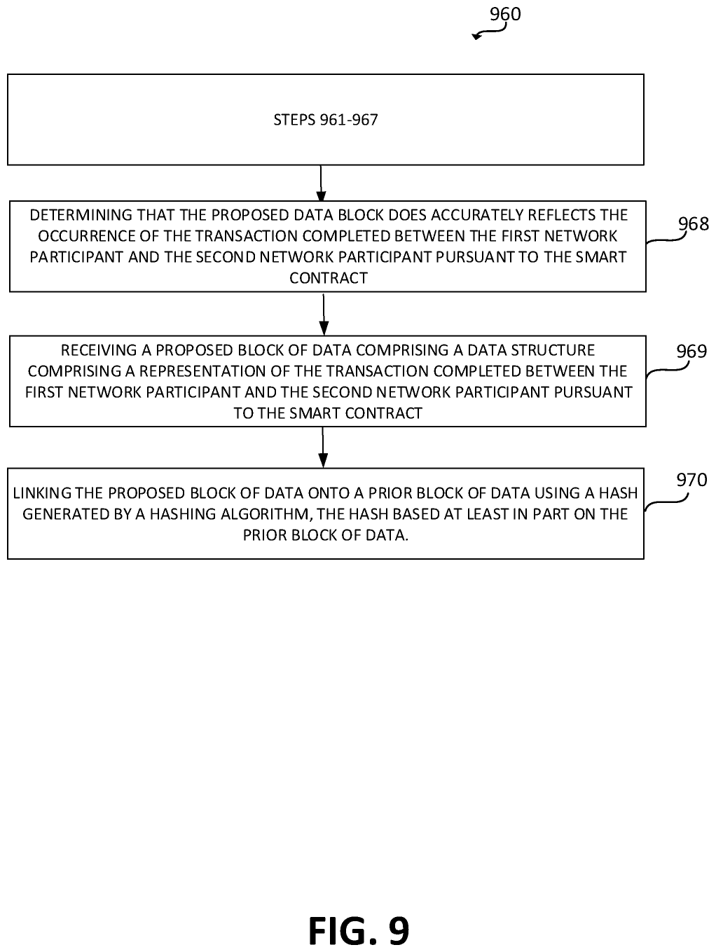

FIG. 8 illustrates an operational flow diagram illustrating an example method 960 that may be implemented to in accordance with one or more embodiments of the present disclosure. At operation 961, method 960 includes establishing a user node for each of a plurality of network participants, each user node comprising an authenticated ID and a digital wallet, the digital wallet configured to manage tokens acquired by the respective network participant associated with the user node. At operation 962, method 960 includes depositing, in exchange for a received amount of fiat currency and at a predetermined exchange rate, a number of disposable tokens into the digital wallet of the first network participant's user node. At operation 963, method 960 includes providing a smart contract to facilitate a transaction between the first network participant and a second network participant, the smart contract comprising transaction terms, the transaction terms comprising a payment term, the payment term comprising an amount of fiat currency. At operation 964, method 960 includes locking, upon receiving a required digital signature or other form of authorization from the first network participant and a required digital signature or other form of authorization from the second digital network, a number of disposable tokens in the digital wallet of the first network participant's user node. At operation 965, method 960 includes releasing, upon receiving an indication of agreement from both the first network participant and the second network participant, the number of tokens from the digital wallet of the first network participant's user node to the digital wallet of the second network participant's user node. At operation 966, method 960 includes receiving a proposed block of data comprising a data structure comprising a representation of the transaction completed between the first network participant and the second network participant pursuant to the smart contract. At operation 967, method 960 includes applying a proof-of-two consensus rule to the proposed block of data to obtain a result
FIG. 9 illustrates an operational flow diagram illustrating additional example operations that may be implemented in connection with example method 960, in accordance with one or more embodiments of the present disclosure. At operation 968, method 960 includes determining that the proposed data block does accurately reflects the occurrence of the transaction completed between the first network participant and the second network participant pursuant to the smart contract. At operation 969, method 960 includes receiving a proposed block of data comprising a data structure comprising a representation of the transaction completed between the first network participant and the second network participant pursuant to the smart contract. At operation 970, method 960 includes linking the proposed block of data onto a prior block of data using a hash generated by a hashing algorithm, the hash based at least in part on the prior block of data.

Referring back now to FIG. 2, one or more UNodes 500 of the present disclosure may include various other components 518 to enhance the efficiency, scalability, and practicability of carrying out transactions. One such other component may be a digital bill component that allows network participants to engage in point-to-point transfers that are configured or optimized to reduce the validation burden on the relevant network participants. Just as a paper bill (such as a $1 bill or a $20 bill) represents an amount of fiat currency that can be exchanged physically in the real world, a digital bill may represent an amount of cryptocurrency (e.g., a number of tokens), but unlike fiat currency the digital bill can only be exchanged in an electronic environment (e.g., such as the blockchain networking environments disclosed herein). That is, a digital bill may represent a number of tokens held by a particular UNode, and the tokens may in turn be supported by any number of underlying transactions that prove that such number of tokens represented by the digital bill is true/valid.

Drawing an analogy for purposes of clarifying the context for use of the digital bill component of the present disclosure, it will be appreciated that in a physical world exchange of paper bills, it is much more preferable to reduce the number of paper bills that need to be exchanged. For example, if one party in the real world is going to pay $1000 cash to a seller for a good, the seller will normally prefer to receive ten $100 USD bills instead of one-thousand $1 USD bills, or worse still four-thousand 25¢ quarters. The reason the seller prefers a reduced number of bills is often because it is much easier and quicker to count and validate that there are ten $100 USD bills present than it is to count up and validate that there are four-thousand 25¢ US quarters. So even though the same monetary value is associated with ten $100 USD bills and four-thousand 25¢ US quarters, the former is much preferred in a typical transactional environment.

Similarly, in a blockchain based transactional environment, some combinations of digital currency are easier to validate than others. For example, if for a given token there are four prior transactions that need to be verified in order to validate that the token may legitimately be used/exchanged for value on the network, the burden to validate the hash value of the block(s) that underly the existence and value of that token is far less than a token having the same value but for which there are, for example, one-hundred prior transactions that need to be verified in order to validate the hash value of the block(s) that underly the existence and value of that token.

As noted above and against the foregoing backdrop, the UNodes of the present disclosure may include a digital bill component configured to generate combinations of digital bills optimized for point-to-point transfers between network participants. Each digital bill may be secured with one or more public/private keys such that the buyer (sender of the bills) and seller (receiver of the bills) can validate each bill that is exchanged between the parties. In generating combinations of digital bills (each of which may represent a value or number of tokens) that amount to an agreed upon payment term for a transaction, digital bill component may be configured to reduce, minimize, or otherwise optimize the combination of bills based on a predetermined criteria or constraint. In many instances, the predetermined criteria or constraint will be based upon minimizing the computational expense of validation by one or both network participants involved in the transaction.

FIG. 10 illustrates a variation on the architecture of components of the example UNode introduced in FIG. 2, here shown equipped with a Digital Bill Component 518A, a Token Based Loan Component 518B, and a BC check Component 518C in accordance with one or more embodiments of the present disclosure.

As noted, digital bill component 518A may be configured to generate combinations of digital bills optimized for point-to-point transfers between network participants. In some embodiments, Digital Bill Component 518A may be configured evaluate a collection of transactions underlying a digital bill associated with one or more tokens in a smart wallet, determine a validation computational expense parameter associated with the collection of transactions, and select a combination of digital bills that both (i) satisfies a payment term of a smart contract, while at the same time (ii) satisfies a preferred or predetermined validation computational expense criteria, or any other criteria preferred between the parties to a proposed transaction. The validation computational expense parameter can refer to the computational weight of validating a collection of transactions underlying a digital bill.

In some embodiments, digital bill component 518A is configured to identify a bundle of transactions that will minimize, reduce, or otherwise optimize the computational validation burden on the other network participant(s) to the transaction (e.g., by identifying the combination of digital bills with that minimizes the total validation computational expense parameter), and may—alone or in combination with smart wallet component 515, smart contract component 514, and/or any other component of systems of blockchain networking environment 100—effectuate transfer of the bills associated with such bundle of transactions to the other network participant. In this way, digital bill component 518A provides a way to lower the computational burden on a transaction by transaction basis, without loss of integrity to the block chain network.

A byproduct of operation of the digital bill component 518A throughout the network is that, as time proceeds and more transactions occur within the network, the computational burden associated with transactions will converge or find equilibrium based on the value of the tokens and/or digital bills being transacted with. Though the computational burden may still increase with time due to the number of transactions underlying a given block or series of blocks in a given chain, the computational burden will be more predictable and grow at a slower rate.

Accordingly, because the nodes associated with the participants to a series of transactions may first perform a bill optimization operation for point-to-point payments, the technology of the present disclosure effectively reduces and sometimes minimizes the computation burden of validation that would otherwise have to be performed by the other participant to the transaction. An immense amount of computational power may be preserved throughout the network as a whole by implementing the technology of the present disclosure.

As further shown in FIG. 10, the UNode may include a token based loan component 518B. Referring briefly to FIG. 3, an INode such as INodeN 200-1 may also include a token based loan component 218B that interacts with the token based loan component 518B to enable the functionality described below. The token based loan component 518B of the UNode may be configured to request a loan from the INode. The token based loan component 218B of the INode may be configured to respond to and fulfill a loan request based on interactions with the UNode over the blockchain network (e.g., over network 400 via communication links 450 of FIG. 1). For example, an INode may receive, evaluate and/or fulfill a loan request from a UNode by transferring a designated number of tokens to the requesting UNode, the number of tokens corresponding to the amount of the loan requested by the UNode and/or the amount approved for the user associated with the given UNode (which may be based, in whole or in part, on a credibility scoring mechanism such as the credibility scoring mechanisms described in U.S. application Ser. No. 16/388,237, which is incorporated herein by reference in its entirety).

The user associated with the UNode (e.g., UNodeN 500-1) may, as part of its loan request, designate a certain amount of funds (e.g., an amount of fiat currency, an amount of an amount of fiat-pegged cryptocurrency (i.e., a token), or a combination of both) for the desired loan. The user associated with the UNode may, as part of its loan request, designate a certain amount (e.g., an amount of fiat currency, an amount of tokens, or a combination of both) for the desired loan. The user associated with the UNode may make a selection providing an indication of the form of funds with which it desires the loan to be fulfilled—either fiat currency, or a fiat-pegged token, or a combination of both. In some embodiments, the user associated with the UNode may also designate an item of collateral that the INode may use to secure the loan. In the blockchain networking environment of the present disclosure, the collateral may include any tangible or intangible asset, note, or other item of value, including but not limited other tokens (from the instant network or any other network, and/or any smart wallet component of an entity operating in another blockchain networking environment) to which the user associated with the UNode is entitled (which entitlement may be redeemable at the time of the request, or at a later date certain).

The INode may provide to the UNode a representation of loan product offerings in response to the UNode's request. A loan product refers to the specific set of details, features, terms, costs, requirements, etc. that define the loan agreement/arrangement between a borrower and a lender. A loan product may be created by a lender and offered to potential borrowers. The user associated with the UNode may interact with and/or select an option from among the representation of loan product offerings via a user interface of the UNode. The loan product offering may include term offerings (e.g., 30 days, 2 years, 30 years, etc.), interest rate offerings associated with one or more portions of the loan amount (or in some cases, an interest rate formula that keys the applicable interest to a number of factors). The interest rate offerings may include one or more rates applicable to borrowed fiat currency, and/or one or more rates applicable to borrowed tokens, and/or one or more blended rates applicable to the value associated with the entire loan, even if the loan involves both tokens and fiat currency. One or more of the loan product offering details may be manipulatable by the user of the UNode via an interface (e.g., the term of the loan, collateral for the loan, the funding date, or any other detail).

In some cases the user may wish to have a portion of their loan fulfilled with fiat currency, and another portion fulfilled with fiat-pegged tokens, and another portion for which either fiat currency or fiat-pegged tokens are an acceptable form of loan fulfillment. In some arrangements, for a portion of the loan that comprises tokens, the user may pay that portion of the loan back by either (1) returning borrowed tokens, or (2) making a payment of fiat-currency to the bank in an amount that corresponds to the value of the tokens, or (3) a combination of (1) or (2). In the representation of loan product offering details to the UNode, the INode may offer incentives for the user of the UNode to accept fiat-pegged tokens instead of fiat-currency as fulfillment of the requested loan. In the case that the user elects that the loan (or a portion of the loan) may be fulfilled via fiat-pegged tokens, the fiat-pegged tokens may be transferred to the UNode upon loan closing. However, the INode need not transfer any fiat currency to the UNode (or a future holder of the loaned token) until an exchange of the fiat-pegged tokens for fiat currency is requested the holding party.

As a result, the institution associated with the INode may maintain possession of the fiat currency backing the loaned tokens and continue to gain value from at least a portion of such fiat currency (e.g., via investments returning interest to the institution associated with the INode) until the time when the loaned tokens are actually requested to be exchanged for fiat-currency at some future date. That is, when the financial institution lends tokens to the borrower, it may set a certain amount fiat currency aside (typically in escrow) so that it has cash-on-hand when the borrower or other recipient of the tokens wishes to exchange the tokens for cash. However, based on probabilities across users, the lending institution may not actually put the entire amount of the loan in escrow. For example, if a user wanted to borrow 100 tokens (and assuming the exchange rate for 1 token was $1 US Dollar), the lending institution may provide transfer 100 tokens to the user at 20% APR with an agreement that the user will make monthly payments of $12 US Dollars to the lender for 1 year. Then, based on probabilities across users, the lender may decide to put $60 US Dollars in escrow to cover instances where a user wishes to exchange one or more tokens for cash. Moreover, through the course of the loan, the institution associated with the INode may be receiving additional fiat-currency from the borrower as per the borrowers agreed upon regular payments for the loaned tokens. Thus, the lender may be making additional interest on far more sources of fiat-currency than it ever could with a traditional fiat-currency based loan. In the scenario above, having transferred the 100 tokens to the user and having placed $60 US Dollars in escrow, the lender can effectively earn interest on (i) the $40 US Dollars it held onto and did not place into escrow, (ii) the loaned tokens at the agreed upon rate (here 20%) until they are paid off or returned, and (iii) the fiat currency that the borrower regularly pays to the lender to cover principal plus interest as part of its payment plan (e.g., here, $12 per month). Sometimes this is referred to herein as double interest.

Though the lending institution may have no guarantee how much time will elapse between the time it transfers the loaned tokens to the UNode and when the UNode (or a direct/indirect recipient of the UNode) will exchange the tokens for fiat currency, the institution associated with the INode may nevertheless associate some value with this time period of potential lapse, and consider this value in offering competitive loan products to users associated with UNodes.

Because lenders may earn “double interest” by implementing the technology of the present disclosure, if desired, the lending institution associated with am INode may offer token based loans with a lower fixed interest rate than a fiat-currency based loan of the same amount. In cases where the user elects to have a portion of their loan fulfilled with fiat currency, and another portion fulfilled with fiat-pegged tokens, the institution associated with the INode may offer a blended interest rate that is based on a first interest rate for the portion of the loan fulfilled with fiat-currency, and a second interest rate for the portion of the loan fulfilled with fiat-pegged tokens.

In another example, the institution associated with the INode may offer a fixed and/or quasi-floating interest rate on loaned tokens. For purposes of the present applications, quasi-floating interest rate may refer to either: (1) an interest rate that is computed based on the amount of time that actually elapses between (i) the time the loaned tokens are transferred to the UNode, and (ii) the time that the loaned tokens and/or the fiat-currency value corresponding to the loaned tokens is paid back to the institution associated with the INode; or (2) an interest rate that is computed based on the amount of time that actually elapses between (i) the time the loaned tokens are transferred to the UNode, and (ii) the time when the borrowing UNode (or a direct/indirect recipient of the tokens originally borrowed by the UNode) exchanges the tokens for fiat currency (e.g., when a recipient of the borrowed tokens requests that a financial institution, such as the institution associated with INode, accept the fiat-pegged tokens in exchange for fiat-currency at the established exchange rate for such tokens); or (3) a combination of (1) and (2).

By applying a fixed and/or quasi-floating interest rate to token based loans, lenders may provide an abundance of additional loan products with enhanced features never before contemplated. For instance, by way of a nonlimiting example, the INode may offer a 5-year token based loan product with a quasi-floating interest rate providing: an interest rate of 5% for borrowed tokens that are actually exchanged for fiat-currency within the first year of the loan, an interest rate of 4% for borrowed tokens that are actually exchanged for fiat-currency within the second year of the loan, an interest rate of 3% for borrowed tokens that are actually exchanged for fiat-currency within the third year of the loan, an interest rate of 2% for borrowed tokens that are actually exchanged for fiat-currency within the fourth year of the loan, and an interest rate of 1% for borrowed tokens that are actually exchanged for fiat-currency within the fifth year of the loan, and even 0% for borrowed tokens that are actually exchanged for fiat-currency after the fifth year of the loan (i.e., the end of the term of the loan, after which the loan would be presumably paid off). Such a quasi-floating interest rate may encourage users to transact with tokens rather than fiat currency. Such a quasi-floating interest rate may further encourage users to transact with other companies that often transact in tokens rather than fiat currency to increase the likelihood that the borrowed tokens will be in circulation for a longer period of time, and thereby that the interest rate applicable the original borrower be lessened.

For both fixed and/or quasi-floating interest rate token based loans, not only are their benefits to the borrower (e.g., the UNode in the example) in that the borrower has a much larger spectrum of loan products to choose from, but the lending institution benefits greatly as well. For example, the lending institution associated with the INode (i.e., the lender) may protect its capital, in many instances to a greater degree than a traditional loan, by keying the interest rate associated with portions of the loaned amount to an amount of time such portions are in circulation before being paid back and/or exchanged for fiat currency. For example, as noted above, the quasi-floating interest rate allows lenders to protect their own investments by basing the interest rate for a loan, in whole or in part, on the amount of time elapsed between the time loaned tokens are transferred to the borrowing UNode and the time when the borrowing UNode (or a direct/indirect recipient of the UNode) exchanges the tokens for fiat currency. At the same time, the UNode (i.e., the borrower/debtor) receives a benefit that it otherwise would not receive for at traditional loan. In particular, taking the nonlimiting example above, if the UNode uses the loaned tokens in the blockchain network to pay other UNodes that continue to use the token in the same form in their transactions (instead of exchanging it for fiat-currency), then the interest rate the borrowing UNode may ultimately be responsible to pay to the lending institution (e.g., the INode) may be reduced dramatically below what the market interest rate for an entirely fiat-currency based loan product would be. Case in point, in an example similar to example above (the 5-year token based loan product), if none of the loaned tokens are exchanged for fiat-currency within the five year term of the loan, the user associated with the loan product may not be responsible for paying any interest for the loan. In other words, if after 5 years the borrowing INode has made all of his/her regular payments in fiat-currency for the loan amount, but the originally borrowed tokens are still in circulation because recipients of the tokens (e.g., parties to whom the borrowing UNode made a payment using the tokens it had borrowed from the INode) have not yet exchanged them for fiat-currency, then the UNode may not have to pay any interest to the institution associated with the INode on that particular loan. The benefits to lending institutions employing embodiments of the present disclosure are extensive. For example, in the example just provided, the escrow funds the financial institution likely set aside to back the token loan still exist (because no one has exchanged their tokens for fiat-currency), yet the lending institution has been paid back full (with fiat-currency) for the value of the token loan all while the tokens are still in circulation.

Thus, the financial institution can freely invest the fiat-currency that the borrower UNode paid back to the lending INode, and at the same time rely on the already escrowed funds to back the tokens still in circulation (in anticipation of the day when some recipient of the tokens decides to exchange them for fiat currency with the financial institution), and therefore the financial institution achieves an enormous benefit (e.g., earning interest on a greater amount of money). Moreover, the financial institution may experience an even further benefit because the borrower UNode may, in addition to his election to repay the principal amount of his loan in fiat currency, he may also elect to pay accrued interest from his loan in fiat currency as well.then, not only can the financial institution be earning interest on all of the fiat currency that the UNode repays the loan with, but can also earn additional interest on the UNode's payment of fiat currency to cover accrued interest as well. Ultimately, embodiments of the present disclosure enable mechanisms for financial institutions to increase their on hand cash holdings while retaining sufficient set-asides back the token-based loans they have issued.

With the flexibility offered by the technology of the present disclosure, financial institutions associated with the INode may use various arrangements to develop a range of products incentivizing a user associated with a UNode to elect a token based loan product rather than a purely fiat based loan product. Where the financial institution decides to offer the token based loan at a fixed and/or quasi-floating interest rate that only slightly benefits the borrower over a traditional loan, the financial institution benefits enormously, because it can effectively earn double interest—i.e., interest on the borrower's loan, and interest on the money paid back by the borrower that the lender can invest freely until the tokens are one day exchanged.

The foregoing 5-year token based loan products are examples only, and many other examples will be apparent to those of skill in the art upon reading the instant disclosure. In some examples, the quasi-floating interest rate applied may even become a negative interest rate (i.e., embedding a potential return to be paid to the UNode (the original debtor)) for tokens that are not exchanged for fiat-currency for extensive periods of time. Modifying the example above, the INode may offer an quasi-floating interest rate incentive as part of the 5 year loan product, wherein the INode will pay the UNode a certain interest rate for loaned tokens that are not exchanged for fiat-currency until after the term of the loan. For instance, the INode may pay the UNode 0.2% interest on each token exchanged for fiat-currency during the first through third years after the end of the loan (i.e., in this example, in the sixth through eight year after the loan was originally funded), the INode may pay the UNode 0.4% interest on each token exchanged for fiat-currency during the fourth through fifth years after the end of the loan (i.e., in this example, in the ninth through tenth year after the loan was originally funded), the INode may pay the UNode 1% interest on each token exchanged for fiat-currency thereafter (i.e., in this example, in the eleventh year after the loan was originally funded, or anytime thereafter). In this way, among others, the institution associated with the INode may incentivize a user associated with a UNode to elect a token based loan product rather than a fiat based loan product.

Moreover in embodiments where a quasi-floating interest rate is implemented in a manner such that at some point a negative interest rate applies where loaned tokens are not exchanged for fiat currency for extensive periods of time (inuring a benefit to the original borrower), the potential for earned interest on such tokens may form the basis for determining one or more terms of a transaction that can be made contingent upon the tokens remaining in circulation for a certain period of time without being exchanged.

For example, suppose a borrower obtains 100,000 loaned tokens on a 5 year repayment term (the repayment being in fiat-currency), with a quasi-floating interest rate applied as follows: 5% annual interest on each token exchanged for fiat-currency during the first year of the loan term, 4% annual interest on each token exchanged for fiat-currency during the second year of the loan term, 3% annual interest on each token exchanged for fiat-currency during the third year of the loan term, 2% annual interest on each token exchanged for fiat-currency during the fourth of the loan, and 1% annual interest on each token exchanged for fiat-currency during the fifth of the loan term. Then, if the loan is repaid in full by the end of the 5 year term, but the tokens are still in circulation, as a borrower incentive based feature of the quasi-floating interest rate, the lender may agree to quasi-floating interest payments to the borrower, for example, as follows: 1% annualized interest on each token exchanged for fiat-currency during the first year after the end of the loan term, 1.5% annualized interest on each token exchanged for fiat-currency during the second year after the end of the loan term, and 2% annualized interest on each token exchanged for fiat-currency during the third year after the end of the loan term or anytime thereafter. Knowing that the loaned tokens could bear interest for the borrower UNode if not exchanged for fiat-currency until after the five-year term, the borrower may present a seller UNode with a more compelling offer for goods or services being transacted for on the block chain network.

For instance, if a seller on the blockchain network is offering a piece of equipment worth $95,000 US dollars (which, for purposes of this example, may be equivalent to 95,000 tokens with a $1 US Dollar-to-1 Token exchange rate), the borrower of the loaned tokens may offer to buy the piece of equipment from the seller for 97000 tokens (2000 more than the asking price) in exchange for the seller agreeing not to exchange the tokens for fiat currency for 8 years. If the seller is in a position to accept such a condition (e.g., because they always deal in tokens, or perhaps because they have other arrangements for their cash and token holdings such that cashing out the 97,000 tokens is not necessary for a period of 8 years or more), then a mutual benefit between the buyer (the borrower) and the seller (the entity to whom the borrower will transfer the tokens) occurs because: (1) the borrower gets a chance to avoid paying interest and actually earn interest in the amount of approximately $5820 on the 97000 tokens, which benefits the borrower by $3820 (e.g., ($97,000×2%×3 years)−($2000 overpayment)=$3820, not accounting for compound interest for simplicity of description in this example), and (2) the seller gets paid 2000 more tokens than the asking price for the piece of equipment. Furthermore, at the same time the borrower and seller are realizing these benefits, the lending institution may further benefit because it is earning interest on the fiat-currency while the tokens are in circulation (which in the common case will be a greater interest rate than the interest rate the lender agreed to pay the borrower in the event of extended token circulation, thereby creating an earned interest split).

The foregoing example just provides one of many ways a borrower and a seller on the blockchain network of the present disclosure may elect to transact on account of the quasi-floating interest rate feature. This example is in no way intended to be limiting, however, and other examples of how to apply the quasi-floating interest rate feature of the present disclosure will become apparent to those of skill in the art upon reading the this disclosure. For instance, the price paid for the good or service over the block chain network of the present disclosure may include further interest splits between network participants as the tokens originally borrowed by the borrowing UNode continue to be used in transactions throughout their circulation on the block chain network prior to being exchanged for fiat currency with the original lender (e.g., the INode).

As will be apparent to those of skill in the art upon reading the foregoing disclosure, the present technology creates a mechanism for creating a debt instrument that can yield enhanced interest benefits for the lender, and in some arrangements may ultimately inure to the financial benefit of both the lender (the INode), and/or the borrower (the UNode), and/or a future seller (another UNode) with whom the borrower transacts in tokens. That is, to the extent loaned tokens survive in the blockchain networking environment without being exchanged for fiat-currency for a period beyond a loan term (or any other term set by the institution associated with the INode), the lender may earn interest on the fiat-currency it has received as payment while retaining the separate funds set aside for escrow to back the still circulating tokens, and in some cases (e.g., depending on the arrangement and depending on how long tokens are in circulation) the loan product may result in an interest bearing asset to the original borrower. In the event it becomes an asset inuring to the benefit of the user associated with the UNode (the borrower), such an asset may be contracted for, be transferrable, salable, used as collateral, or otherwise as assets in any manner that assets may be used in commercial engagements.

In further embodiments of the present disclosure, tokens may be programmable. In particular embodiments, financial institution based network participants (or other participating entities) may program tokens to restrict or otherwise specify what or when the tokens may or may not spent upon by the borrower. For example, the underlying code that comprise the tokens may be configured with one or more of a code restricting the first transfer of the tokens from the borrower to a particular category of recipients, or to a specified recipient. In another example, the underlying code that comprise the tokens may be configured with one or more of a code restricting the timing of the first transfer of the tokens from the borrower to one or more recipients (which may or may not be specified in the code). In another example, the underlying code that comprises the tokens may be configured with one or more of a code specifying the types of goods or services that may be purchased using the tokens (e.g., real estate, equipment, vehicles, legal services, accounting services, etc.). Any one or more elements of the block chain network disclosed in the present disclosure may be configured to detect when an attempt to spend a token is in violation of a restriction embedded within the token. For example, if UNode 1 borrows 100,000 tokens from an INode to purchase construction equipment (e.g., an excavator) from another network participant (UNode 2), for UNode 1's business, INode may wish to ensure that UNode 1 actually spends the 100,000 tokens to purchase the anticipated construction equipment. With the technology of the present disclosure, INode may embed the tokens with code that restricts UNode 1's ability to transfer the tokens to any other recipient besides UNode 2, and/or restricts UNode 1's ability to transfer the tokens for any other purpose besides the purchase of the anticipated construction equipment.

In still further embodiments, network participants may program tokens such that the tokens may be disabled or otherwise prevented from being utilized in a transaction other than as specified by the borrowing participant. In this way, lenders may implement technical features embedded within the tokens they lend to borrowers such that the lenders risk of loss (e.g., loss on default) is reduced considerably. It is well known in the field of borrowing and lending money, that borrowers often misrepresent the manner in which borrowed funds will be used, and the lender necessarily must exercise some element of trust in the borrower that the funds will be spent in accordance with what the borrower has stated or represented. However, as is often the case, borrowers may not stay true to their representations as to how the borrowed funds will be spent. Indeed, borrowers may elect to spend borrowed funds for a purpose which, had the lender known of such purpose, the lender would not have approved or issued the loan to the borrower. Thus, the market is in desperate need of a solution whereby lenders may exercise a greater degree of control over the funds that they borrow.

Extending the example above—where UNode 1 borrows 100,000 tokens from an INode to purchase construction equipment (e.g., an excavator) from another network participant (UNode 2), for UNode 1's business—suppose that after borrowing the 100,000 tokens from the INode, UNode 1 instead besides to use 10,000 tokens to pay off a vacation expense, while only using 90,000 tokens to buy a used excavator. Upon attempting to transfer 10,000 of the borrowed tokens to a recipient other than UNode 2 for the purpose of paying our vacation expenses, one or more elements of the block chain network of the present disclosure may recognize that such a transfer would be in violation of the agreed-upon loan arrangement (e.g., based on the code embedded within the tokens), and may not only prevent the tokens from being transferred to the other recipient, but may also disable the 10,000 tokens (and perhaps the entire amount, 100,000 tokens) such that the tokens are of no use to UNode 1 without further authorization and/or unblocking of the tokens (e.g., by INode). In this way, as noted above, lenders can reduce their risk of loss for each loan arrangement enter into that utilizes such programmable tokens. Such programmable tokens may also be referred to herein as purpose-defined tokens. Purpose defined tokens, for clarity, comprise tokens that are programmed to be spent in a particular way, or at a particular time, or to a particular recipient in any given transfer after the original transfer from the lending participant to the borrowing participant (e.g., for the first transfer of tokens, the second transfer of tokens, the nth transfer of tokens, etc.).

Moreover, in some embodiments, a lender associated with an INode may program tokens such that the cash out function of one or more tokens may, at any time at the INode's election or pursuant to agreement, be temporarily or permanently disabled. For example, an INode may disable an amount of loaned tokens that corresponds to an unpaid amount that the borrowing UNode agreed to pay at a time certain. For instance, suppose a user associated with a UNode had borrowed 1000 tokens from an institution associated with an INode, and had agreed to pay back the loan, with interest, in the amount of $100 on the first day of each month for a 12 month period (for a total of $1200 with interest). Further suppose that this user failed to make his third month's payment on the first day of the month, and planned to instead make the payment on the tenth day of the month. In this situation, utilizing the technology of the present disclosure, to reduce its risk of loss on the borrower's default, the INode may (automatically or selectively), disable the cash out function of 100 tokens (which may correspond to the $100 US Dollars which the user associated with UNode failed to pay), or any other desired or agreed upon amount for such circumstance (e.g., the entire amount of uncashed tokens loaned to the user, or the entire amount of uncashed tokens loaned to the user and still in the user's possession, or any other amount as may be determined and/or defined as part of the loan agreement), unless and until the user associated with the UNode made the $100 US Dollar payment and any associated penalties. In this way, a lender associated with an INode can lower losses and risks of loss on loans upon which the borrowing UNode defaults. Unlike traditional fiat lending (where if borrower defaults the entire unpaid loan amount is lost), with the technology of the present disclosure only a portion of the loan amount may be lost because the fiat-currency that corresponds to any uncashed tokens is actually held by the lender associated with the INode, and is thereby protected from misuse. Accordingly, on account of the technology of the present disclosure, lending institutions can lessen the risks associated with lending and ultimately offer lower interest rates.

It will be appreciated that the technology of the present disclosure may be applicable in many environments, even those beyond the borrowing and lending arrangement examples provided above. For example, purpose-defined tokens may provide a mechanism for donors to ensure that the funds that they donate are used in the manner or for the purpose promised by the donee. In another example, the actual spending of earmarked funds may be electronically ensured where purpose defined tokens are the elected medium for such funds. The technology of the present disclosure enables enhanced interest bearing arrangements that exploit the time between loan commencement and repayment in fiat-currency and/or token exchange for fiat-currency, introducing a number of features, including a feature that allowing intuitions, including those associated with INodes in blockchain networking environments of the present disclosure, to create an entirely new lineup of loan products with new incentives and advantages that far exceed the benefits of a traditional fiat-based loan product, while still enabling such institutions to protect their capital to a desired degree of certainty. Thus, the risk/benefit calculus can incorporate new factors that lead to potentially greater incentives, and in some instances greater certainty and/or flexibility, on both sides of the blockchain token based loan—e.g., both for the institution associated with the INode (i.e., the lender) and the user associated with the UNode (i.e., debtor).

In view of the foregoing, the present disclosure presents a technical solution for providing advanced token based loan features enabling a broader range of loan products, and creating more intelligent relationships between lenders and borrowers interacting on blockchain networks. Such systems and methods may involve generating token based loans in a blockchain supported network. This may include receiving a loan request from a first network participant, the loan request including an amount of fiat-currency; determining a number of tokens that correspond to the amount of fiat-currency, the determination based on a pre-determined exchange rate of fiat currency to tokens; and offering one or more loan products to the first network participant based on the loan request, the one or more loan products including loan terms comprising a quasi-floating interest rate associated with the number of tokens, wherein the quasi-floating interest rate is an interest rate applicable to one or more of the number of tokens based on an amount of time elapsed between a time the tokens are transferred to the first network participant and the time the tokens are (i) returned by the first network participant as repayment, and/or (ii) paid for by the first network participant in fiat-cash, and/or (iii) exchanged for fiat currency by either the first network participant or a direct or indirect payee of the first network participant; receiving an indication of selection and acceptance of the terms of one of the one or more loan products by the network participant; and/or transferring the determined number of tokens to the first network participant in accordance with the loan product associated with the received indication, without transferring the fiat currency corresponding to the amount of fiat-currency to the first network participant.

In some embodiments, the token based loan systems and methods of the present disclosure may include exchanging, in response to a request from a holder of one or more of the number of tokens, an amount of fiat currency for an amount of the one or more of the number of tokens at the predetermined exchange rate. In some embodiments, the token based loan systems and methods of the present disclosure may include determining the date of the exchange; and/or determining the date upon which a token of the number of tokens was transferred to the first network participant pursuant to the loan product associated with the received indication.

In some embodiments, the token based loan systems and methods of the present disclosure involve determining the quasi-floating interest rate applicable to the exchanged tokens based on the amount of time elapsed between the date of the exchange and the date upon which a token of the number of tokens was transferred to the first network participant. They systems and methods may further involve applying the quasi-floating interest rate to the number of tokens exchanged to determine a first interest accrual amount; and/or applying the first interest accrual amount to a principal amount associated with the loan product associated with the received indication.

In some embodiments the quasi-floating interest rate decreases with increased time elapsed between a time the tokens are transferred to the first network participant and the time the tokens are exchanged for fiat currency. In some embodiments the quasi-floating interest rate may become a negative interest rate if the time elapsed between a time the tokens are transferred to the first network participant and the time the tokens are exchanged for fiat currency exceeds a predetermined threshold. In some embodiments, the threshold is equivalent to the term of the loan product associated with the received indication. In other embodiments the threshold is greater than the term of the loan product associated with the received indication. In other embodiments the threshold is less than the term of the loan product associated with the received indication.

In some embodiments, the quasi-floating interest rate changes during a term of the loan and/or the quasi-floating interest rate formula/scale changes during a term of the loan based on one or more criteria being met or failing to be met, as defined within the loan product for a particular loan.

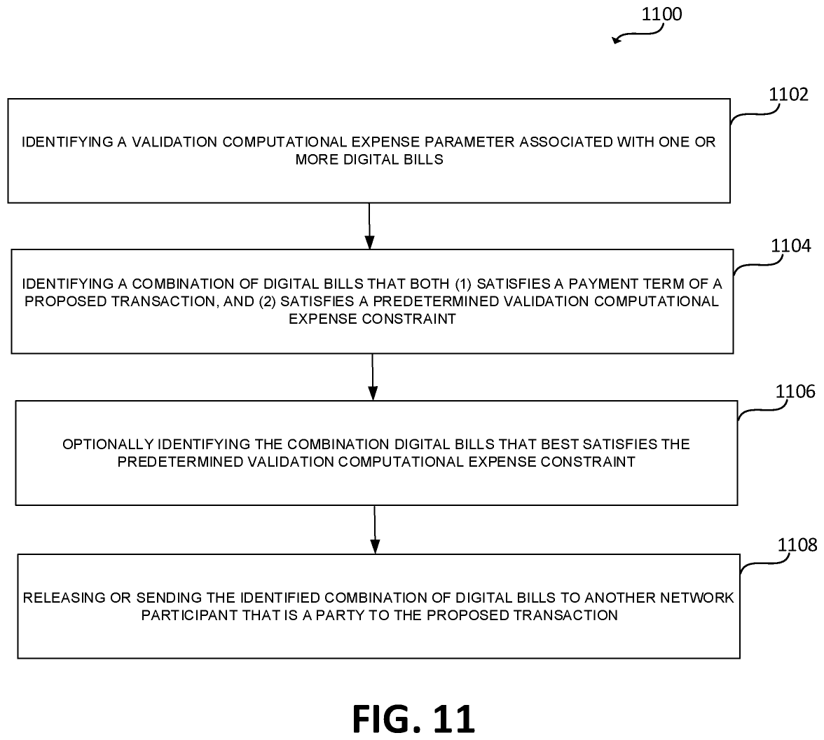

FIG. 11 illustrates an operational flow diagram illustrating an example method 1100 that may be implemented to in accordance with one or more embodiments of the present disclosure. At operation 1102, method 1100 comprises identifying a validation computational expense parameter associated with one or more digital bills. At operation 1104, method 1100 comprises identifying a combination of digital bills that both (1) satisfies a payment term of a proposed transaction, and (2) satisfies a predetermined validation computational expense constraint optionally identifying the combination digital bills that best satisfies the predetermined validation computational expense constraint. At operation 1106, method 1100 comprises. At operation 1108, method 1100 comprises: releasing or sending the identified combination of digital bills to another network participant that is a party to the proposed transaction.

Thus, instead of exchanging a lump sum of tokens randomly—each of which may have any number of underlying transactions which need to be validated to verify the validity of the token—the technology of the present disclosure may be configured to identify, determine, and/or generate a combination of digital bills for a point-to-point transaction such that the number of transactions the other party must validate (or some other element that the other party mush validate, depending on the validation algorithm employed) to settle or otherwise complete a given transaction is reduced, minimized, or otherwise optimized. The systems and methods of the present disclosure may utilize digital bills to enable computationally lightweight point-to-point transfers between network participants.

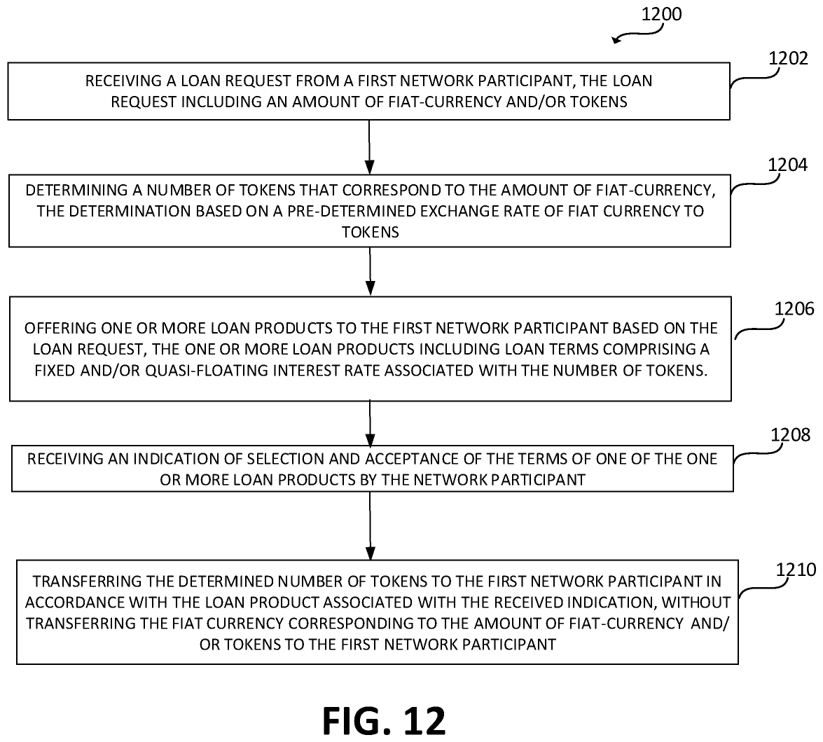

FIG. 12 illustrates an operational flow diagram illustrating an example method 1200 that may be implemented to in accordance with one or more embodiments of the present disclosure. At operation 1202, method 1200 comprises receiving a loan request from a first network participant, the loan request including an amount of fiat-currency. At operation 1204, method 1200 comprises determining a number of tokens that correspond to the amount of fiat-currency, the determination based on a pre-determined exchange rate of fiat currency to tokens. At operation 1206, method 1200 comprises offering one or more loan products to the first network participant based on the loan request, the one or more loan products including loan terms comprising a quasi-floating interest rate associated with the number of tokens. The quasi-floating interest rate is an interest rate applicable to one or more of the number of tokens based on an amount of time elapsed between a time the tokens are transferred to the first network participant and the time the tokens are exchanged for fiat currency. At operation 1208, method 1200 comprises receiving an indication of selection and acceptance of the terms of one of the one or more loan products by the network participant. At operation 1210, method 1200 comprises transferring the determined number of tokens to the first network participant in accordance with the loan product associated with the received indication, without transferring the fiat currency corresponding to the amount of fiat-currency to the first network participant.

Referring back to FIG. 10, another such other component 518 of an example UNode may include a blockchain (BC) check component 518C, where the BC check component 518C is configured to enable a UNode to issue a blockchain based electronic check as a form of payment to other network participants (e.g., other UNodes). The BC check is an electronic check that can be transmitted and verified over a blockchain network, while coordinating with financial institutions associated with network participants to ensure the amounts of funds needed to support the BC checks are locked, frozen, or otherwise restricted from further use. The BC check may be configured to support payments in the form of fiat-currency and/or tokens. The BC check of the present disclosure is different from conventional checks in that, for example, (1) it is in a completely electronic form that is secured by blockchain verification/validation/authentication technology including the technologies of the present disclosure, (2) it may be written for both or either of fiat-currency and/or tokens, (3) it is pre-validated and pre-authorized before being issued and/or before being transferrable, (4) it nullifies or reduces the risk of being bounced when cashed by the recipient, (5) it prevents the issuer from double-spending the same funds, (6) it is traceable, (7) it is terminable in the event of loss or misuse, (8) it is replaceable in the event of loss, (9) it requires fewer authorization/validation steps before being cashed, and involves fewer entities for the same purpose, etc.

Significantly, by offering payment in the form of a BC based electronic check, a user may issue a check to a recipient that designates an amount of either or both fiat-currency or tokens, and a recipient may cash the BC check while avoiding a series of processes commonly performed by financial institutions in connection with cashing traditional checks.

For example, in the traditional checking environment, if a first person (“Person A”) writes a check to a second person (“Person B”), when Person B goes to his/her banking institution (“Bank B”) to cash the check, Bank B must communicate and coordinate with Person A's bank (“Bank A”) to determine whether or not Person A actually has access to a sufficient amount of fiat funds to cover the amount of the check that was written (i.e. sufficient funds to support the transfer of funds from Person A's account to Person B as detailed on the check). Bank B must engage in a series of steps (which can include third party authentication steps) in connection with both the issuer of the check (Person A) and the recipient of the check (Person B) in order to execute the transaction detailed on the check. Sometimes the back-and-forth interactions between banking institutions in the traditional check scenario is referred to as “clearing” (e.g., Bank B clears the check with Bank A, and then receives the funds for Person B from Person A's account at Bank A). In the blockchain networking environment of the present disclosure, if a user of a UNode issues a BC check to another UNode, a number of the interactions required between banking institutions in the traditional checking scenario can be avoided and the overall process streamlined.

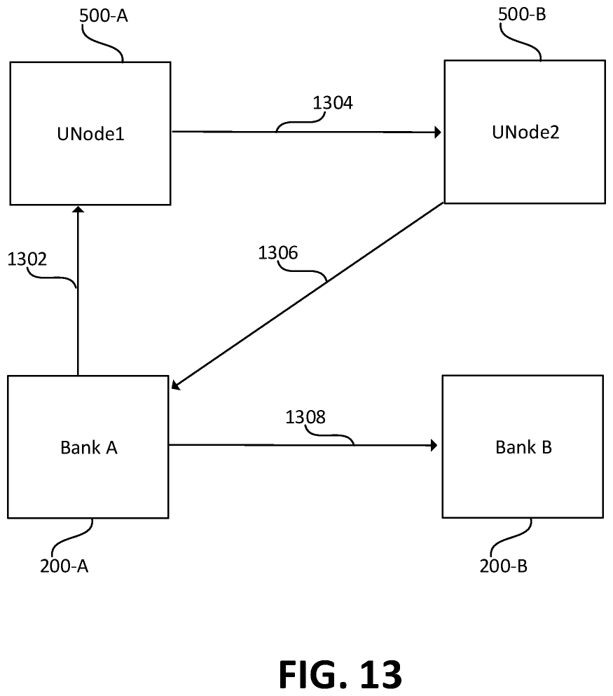

For example, referring to FIG. 13, UNode 500-A may be associated with a person, Person A, who wishes to make a payment using a BC check to Person B, who is associated with UNode 500-B. Among other components, one or more of UNode 500-A and UNode 500-B may be equipped with a BC check component such as BC check component 518C introduced in connection with the example UNodeN 500-1 of FIG. 10. The BC check component of UNode 500-A may be configured to generate an interface with editable fields and selectable options whereby Person A may enter the details (e.g., the amount of fiat-currency or tokens the BC check is to be issued for, the account from which the amount is to be drawn, an issuance date, an expiration date, a date range within which the BC check may be remitted or paid out, the name or other identifier associated with the person/entity to whom the check is to be directed, other limitations or restrictions as may be specified by the issuer, etc.) of an BC check they wish to generate and subsequently issue to someone (e.g., to Person B via UNode 500-B) over a blockchain network in connection with one or more embodiments of the present disclosure.

In some embodiments, the BC check component 518C of UNode 500-A may prevent the generation and/or issuance of a BC check if one or more prerequisites are not satisfied. Satisfaction of such prerequisites may be determined by one or more components of UNode 500-A prior to commencing the generation and/or issuance of a BC check. Such prerequisites may include: (1) sufficient funds available to the user associated with UNode 500-A to support the BC check that the user has requested be generated and/or issued, and/or (2) sufficient authentication of the user attempting to make the request for the generation and/or issuance of a BC check, and/or (3) sufficient creditworthiness if the amount of the BC check requested would draw upon a line of credit, and the like.

For example, if Person A makes a request via its UNode 500-A to generate a BC check in the amount of $350 US Dollars to be sent to Person B's UNode 500-B, one or more components of UNode 500-A may first check person A's bank account balance (e.g., which may be available to or accessible via the digital wallet of the UNode 500-A) to determine whether there is at least $350 US Dollars available (or, in some embodiments, to determine whether there is at least an equivalent amount of tokens available that could be exchanged for $350 US Dollars at a predetermined exchange rate) for Person A to transfer. If there are sufficient funds available (e.g., if there are at least $350 US Dollars in the user's digital wallet, or there is at least $350 US Dollars in the user's bank account (which may or may not be reflected in and accessible via the user's digital wallet)), UNode 500-B may authorize the request and one or more elements of the system may generate the BC check in the amount of $350 US Dollars for the anticipated transmission to UNode 500-B (e.g., transferred to the digital wallet of Person B's UNode 500-B).

In another example, if Person A makes a request via its UNode 500-A to generate a BC check in the amount of 200 tokens to be sent to Person B's UNode 500-B, one or more components of UNode 500-A may first check person A's bank account balance (e.g., which may be available to or accessible via the digital wallet of the UNode 500-A) to determine whether there is at least 200 tokens available (or, in some embodiments, to determine whether there is at least an equivalent amount of fiat-currency available that could be exchanged for 200 tokens at a predetermined exchange rate) for Person A to transfer. If there are sufficient funds available (e.g., if there are at least 200 tokens in the user's digital wallet, or there is an amount of fiat currency in the user's bank account (which may or may not be reflected in and accessible via the user's digital wallet)), UNode 500-B may authorize the request and one or more elements of the system may generate the BC check in the amount of 200 tokens for the anticipated transmission to UNode 500-B (e.g., transferred to the digital wallet of Person B's UNode 500-B).

In another example, if Person A makes a request via its UNode 500-A to generate a BC check in the amount of $100 US Dollars and 250 tokens to be sent to Person B's UNode 500-B, one or more components of UNode 500-A may first check person A's bank account balance (e.g., which may be available to or accessible via the digital wallet of the UNode 500-A) to determine whether there is at least (i) 250 tokens available (or, in some embodiments, to determine whether there is at least an equivalent amount of fiat-currency available that could be exchanged for 250 tokens at a predetermined exchange rate) for Person A to transfer, and, in addition to (i), to determine that (ii) there is another $100 US Dollars available (or, in some embodiments, to determine whether there is an additional equivalent amount of tokens available that could be exchanged for $100 US Dollars at a predetermined exchange rate). If there are sufficient funds available to satisfy both (i) and (ii) (e.g., if there are at least 250 tokens and $100 US Dollars in the user's digital wallet, or there is an amount of fiat currency in the user's bank account (which may or may not be reflected in and accessible via the user's digital wallet)), UNode 500-B may authorize the request and one or more elements of the system may generate the BC check in the amount of 250 tokens and $100 US Dollars for the anticipated transmission to UNode 500-B (e.g., transferred to the digital wallet of Person B's UNode 500-B). In some embodiments, one or more elements of the blockchain platform of the present disclosure may prohibit and prevent the UNode from issuing checks for amounts of fiat-currency and/or amounts of tokens that exceed the amount available to the user through the account(s) (e.g., bank account(s)) from which the funds are to be drawn. For example, the UNode may be equipped with a local utility that prevents the UNode from issuing checks for amounts of tokens that exceed the amount held in the user's bank account that is associated with the requesting UNode (which may, in some embodiments, be available to and/or accessible from the requesting UNode's smart wallet (a.k.a. digital wallet). Moreover, once a check is generated and/or issued in connection with a UNode's request, one or more elements of the blockchain network of the present disclosure may lock up the amount of tokens and/or fiat-currency that the issued check calls for such that the user of the requesting UNode cannot double spend. For example, a UNode may include a local utility that locks up the amount of tokens and/or the amount of fiat-currency the issued check calls for such that a user of the UNode cannot double spend. In some embodiments, the UNode may communicate with the bank account of the user associated with the UNode for this purpose.

For example, as part of the BC check generation process, or as part of a process following such check generation process, one or more elements of the blockchain platform of the present disclosure (e.g., UNode 500-A) may lock up the number of tokens and/or lock up the fiat-cash in Person A's accounts that are needed to support the check being generated such that the same funds cannot be used to support another note or transaction. For instance, upon Person A's request for a BC check to be written via the blockchain platform of the present disclosure, the smart wallet component (alone or together with other components) of UNode 500-A may (alone or in coordination with the banking institution that hosts Person A's bank account) transfer into an escrow account the number of tokens and/or fiat-currency needed to support the BC check. In another example, the smart wallet component locks up or otherwise freezes the tokens and/or fiat-currency needed to fulfill the BC check such that the tokens and/or fiat-currency cannot be used, moved, or otherwise transferred to another source unless and/or until the BC check is cancelled, destroyed, expires, or is otherwise disabled prior to being sent to and/or cashed by the intended recipient of the BC check (e.g. Person B).

In some embodiments, locking tokens imposes one or more restrictions on the tokens such that they cannot be used, moved, or otherwise transferred to another source absent the performance of a predefined action that causes a release of such restriction. In some embodiments, locking tokens may involve embedding additional code within the code that defines the token, the additional code restricting the ability of the particular tokens within which it is embedded from being used other than for the BC check to which they are associated. In some embodiments, locking fiat-currency imposes one or more restrictions on an amount of fiat-currency such that the amount of fiat-currency cannot be used, moved, or otherwise transferred to another source absent the performance of a predefined action that causes a release of such restriction. In some embodiments, locking fiat-currency may involve (i) moving the fiat-currency in the user's bank account (or in the user's digital wallet) into an escrow account that is inaccessible to the issuing user, and/or (ii) coordinating with the banking institution hosting the user's bank account such that the banking institution freeze the amount of fiat-currency for all purposes other than for supporting the BC check issued by the user (e.g., coordinating with the banking institution such that the institution will not allow the funds to be used in any manner except that the recipient of the BC check may cash the BC check and obtain the funds).

In still further embodiments, one or more elements of the blockchain platform of the present disclosure may prohibit and prevent the UNode from issuing checks over a certain predefined amount of fiat-currency and/or amount of tokens, regardless of how much funds the user may have in their accounts. For example, the UNode may be equipped with a local utility that prevents the UNode from issuing BC checks for amounts over $10,000 US Dollars, thereby further limiting exposure in the event of some attempted fraud.

As such, extending the example above, upon submission of BC check details via Person A's UNode 500-A, UNode 500-A may generate a BC check that may be issued and sent (automatically or upon further user selection) to the network participant that is the intended recipient, i.e., Person B. Person B's UNode 500-B may receive the BC check. Upon receipt of the BC check from UNode 500-A, UNode 500-B may generate and/or display a notification indicating receipt of the BC check. In some embodiments, BC checks may be located in (or represented as being located within) a digital wallet of a UNode, the digital wallet being managed by a smart wallet component such as smart wallet component 515 discussed in connection with FIG. 2. Thus, in some embodiments a smart wallet component of a UNode (e.g., smart wallet component 515 of example UNodeN 500-1 of FIG. 10) may operate together with the BC check component of the UNode (e.g., BC check component 518C of UNodeN 500-1 in FIG. 10) to perform operations for the generation, storage, issuance, transmission, receipt, and/or representation of such BC checks.

Once Person B (via their UNode 500-B) is in receipt of the BC check, Person B may wish to obtain the funds delineated by the BC check. Person B (now in possession of the BC check) may present, send or otherwise transmit the BC check (together with Person B's account details at their own banking institution) to Bank A in order to cash the check. That is, once the BC check from UNode1 has been received by UNode2, UNode2 may obtain the funds associated with the BC check by submitting the BC check directly to Person A's bank (Bank A) together with Person B's account details at their own banking institution where they wish the funds to be transferred (here, Bank B). Using Person B's account details, Bank A may then deposit the amount of funds (either in token currency or in fiat currency or both) directly into Person B's account at Bank B. It should be noted that Bank A and Bank B in the above examples may also be associated with nodes of the blockchain network of the present disclosure, and may be equipped with a digital wallet managed by one or more components of such nodes (e.g., a digital wallet managed by a smart wallet component and/or wallet interaction component in the case of either an INode or a Unode associated with the Bank).

Note that in the foregoing example scenario, Person B may cash the BC check through Bank A such that the funds are transferred to Person B's account at Bank B without Person B ever directly contacting Bank B and without Bank B ever having to “clear” the check with Bank A. Utilizing the BC checks of the present disclosure, pre-authenticated and pre-validated token transfers may be made from a source bank to a recipient bank without the recipient bank and the source bank having to engage in a number of authentication steps prior to the source bank transferring the funds to the recipient bank. This is unlike the traditional model where, upon receiving a check a person will visit their own bank first (or another bank that is not the bank of the person who issued the check (i.e., the source bank)), who will then communicate with the bank of the person who issued the check.

Accordingly, in embodiments of the present disclosure that support BC based checking, the banking institution associated with a network participant need not conduct the steps associated with traditional check clearing in connection with another network participant's banking institution. This is enabled, in part, because one or more nodes of the blockchain network described herein: (1) have concurrent knowledge of (i) the amount of funds (e.g., fiat currency) in the associated users' bank accounts (which may or may not be reflected in the user's digital wallet), and/or (ii) the amount of in the associated users' accounts (e.g., tokens in the issuing UNode's digital wallet), and/or (iii) the exchange rate at which tokens and fiat currency may be exchanged back and forth; and (2) are configured to optionally impose restrictions on the transferability of such funds (e.g., coordinating the freezing of fiat-currency, and/or the lock up of tokens) in connection with BC check generation and/or issuance. The technology of the present disclosure thus ensures that when a UNode is in receipt of a BC check of a particular amount, the user associated with the recipient UNode can, without worry or risk of having received a bad check, proceed to cash the BC check with confidence that it will be funded in full from the appropriate source. Thus, among other things, the “insufficient funds” and “bounced checks” problems of conventional checking mechanisms are entirely avoided, and no one network participant can engage in fraudulent checking activities one person while awaiting the “clearing” process for a check the user issued to another person.

Referring to the example illustrated in FIG. 13, the smart wallet component and BC check component of UNode1 may generate a BC check in response to the input provided by Person at via UNode1. After UNode 1 requests that a BC check be generated, but prior to generating the BC check, one or more components of the blockchain platform of the present disclosure may, alone or in coordination with other entities/components (e.g., the user's banking institution, determine if UNode1 has access to enough funds to support the BC check requested to be generated. An example of such a determination is denoted by arrow 1302 in FIG. 13 (Bank A determining if there are sufficient funds and/or providing UNode1 with the result of the determination or the information UNode1 would need to make the determination locally). If sufficient funds exist, the BC check will be generated and the BC check may be made available to UNode1 for issuance to the intended recipient. In some embodiments, the BC check may be reflected in the digital wallet of UNode1 until it has been transmitted, transferred, or otherwise sent to UNode2 where it may then be reflected in the digital wallet of UNode2. Referring to FIG. 13, arrow 1304 indicates that a BC check is sent from UNode1 to UNode2 (e.g., the BC check is sent from the digital wallet of UNode1 to the digital wallet of UNode2). Thereafter, as indicated by arrow 1306, UNode2 may cash the BC check by sending it, together with the UNode2 user's bank account details (e.g., the routing and account number at Bank B), to Bank A. Bank A may then transfer the funds designated by the BC check to the bank account at Bank B that corresponds to UNode2 user's bank account details. This transfer of funds from Bank A to Bank B is denoted by arrow 1308 in FIG. 13.

Because the aforementioned BC checks may exist in or be reflected within the digital wallet of the user who holds the BC check at any given time, and because the digital wallet of the user is typically maintained on a mobile device (e.g., a smartphone), it is possible that a user in control of a BC check misplaces or otherwise loses their digital wallet before transmitting and/or cashing the BC check. In this event, the recipient of the BC check (i.e., the entity who lost their digital wallet) may notify the sender of the BC check (e.g., by email or by phone, or a secure alert web application). The sender of the BC check may send a copy of a canceled version of the BC check to its financial institution (e.g., over the blockchain platform network). Thereafter, the sender's financial institution may compare the received copy of the canceled BC check with a previously stored copy of the BC check and, upon a verification, proceed to cancel the BC check and release any lock, freeze or other restriction on the corresponding funds such that the funds are re-accessible to the sender. The sender's financial institution may flag, mark, or otherwise provide a status indicator denoting the canceled status of the BC check. In some embodiments, the sender's digital wallet may similarly impose or reflect a flag, mark, or otherwise provide a status indicator denoting the canceled status of the BC check.

It is further possible that both the sender and the recipient lose their digital wallets prior to a BC check being cashed. In such a case, the sender can contact its financial institution to cancel the BC check and either or both (i) release the locked tokens back to the sender, e.g., release them back into the sender's digital wallet, and/or (ii) lift the freeze on the frozen fiat-currency, and/or (iii) release escrowed funds (either escrowed fiat currency or escrowed tokens) back into the sender's respective accounts, etc. In embodiments of the present technology, a financial institution may be associated with an INode or a UNode that, through one or more components, may coordinate with users who have lost their digital wallet containing devices, and may restore some or all copies of any previously cashed, uncashed, or cancelled BC checks (with their corresponding status) to a new device acquired by the user. In this way, financial institutions registered with the blockchain network can provide restoration services to their members in order to restore appropriate BC checks to appropriate network participants (e.g., into appropriate digital wallets hosted by new devices of the network participants), should an event occur where a device hosting a digital wallet is misplaced, lost, damaged, stolen, or otherwise removed from the control of the authorized user.

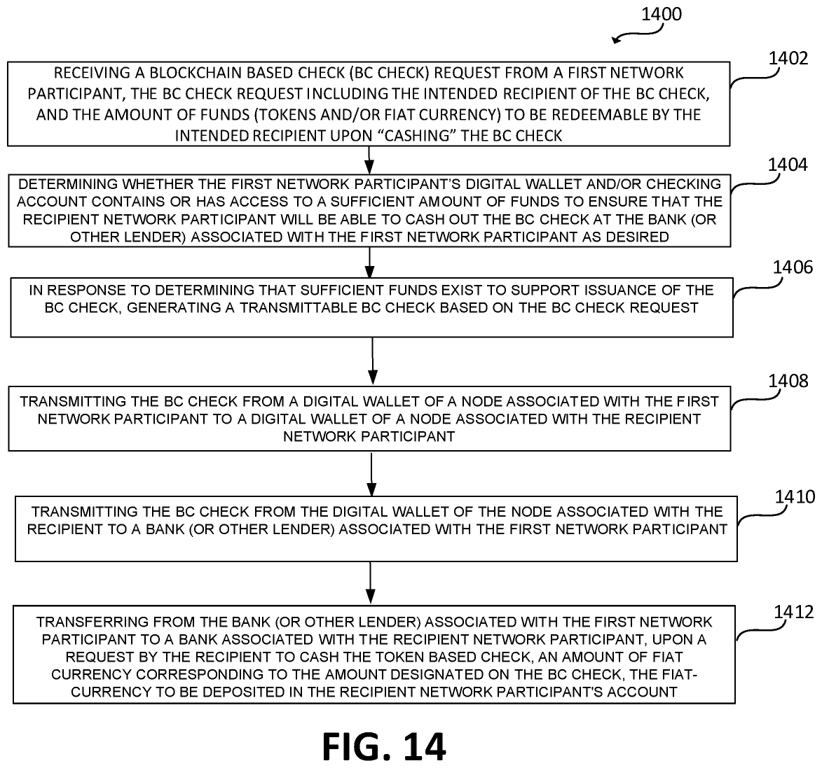

FIG. 14 illustrates an operational flow diagram illustrating an example method 1400 that may be implemented to in accordance with one or more embodiments of the present disclosure. At operation 1402, method 1400 comprises receiving a BC check request from a first network participant, the BC check request including the intended recipient of the BC check, and the amount of funds (e.g., tokens and/or fiat currency) to be redeemable by the intended recipient upon cashing the BC check. At operation 1404, method 1400 comprises determining whether the first network participant has access to a sufficient amount of funds (whether via their associated bank account(s) or their digital wallet(s)) to ensure that the recipient network participant will be able to cash the BC check at the bank associated with the first network participant as desired. At operation 1406, method 1400 comprises, in response to determining that sufficient funds exist to support issuance of the BC check, generating a transmittable BC check based on the BC check request. At operation 1408, method 1400 comprises transmitting the BC check from a node (e.g., from the digital wallet of such node) associated with the first network participant to a node (e.g., to the digital wallet of such node) associated with the recipient network participant. At operation 1410, method 1400 comprises transmitting or otherwise providing the BC check from the node (e.g., from the digital wallet of such node) associated with the recipient to a bank associated with the first network participant, whereupon the bank draws the funds called for in the BC check out of the account of the first network participant. At operation 1412, method 1400 comprises, upon a request to cash the BC check, transferring from the first network participant's account at the bank associated with the first network participant to the recipient network participant's account at the bank associated with the recipient network participant, an amount of funds (e.g. fiat currency) corresponding to the amount designated on the BC check.

Among other benefits, a person of ordinary skill in the art will appreciate that the BC checking systems and methods disclosed herein may avoid bounced checks, provide a simpler clearing process, enable quicker payments and lower processing costs, enable the cancelation and replacement of “lost checks” at more affordable rates, and altogether avoid the need for paper check printing and mailing.

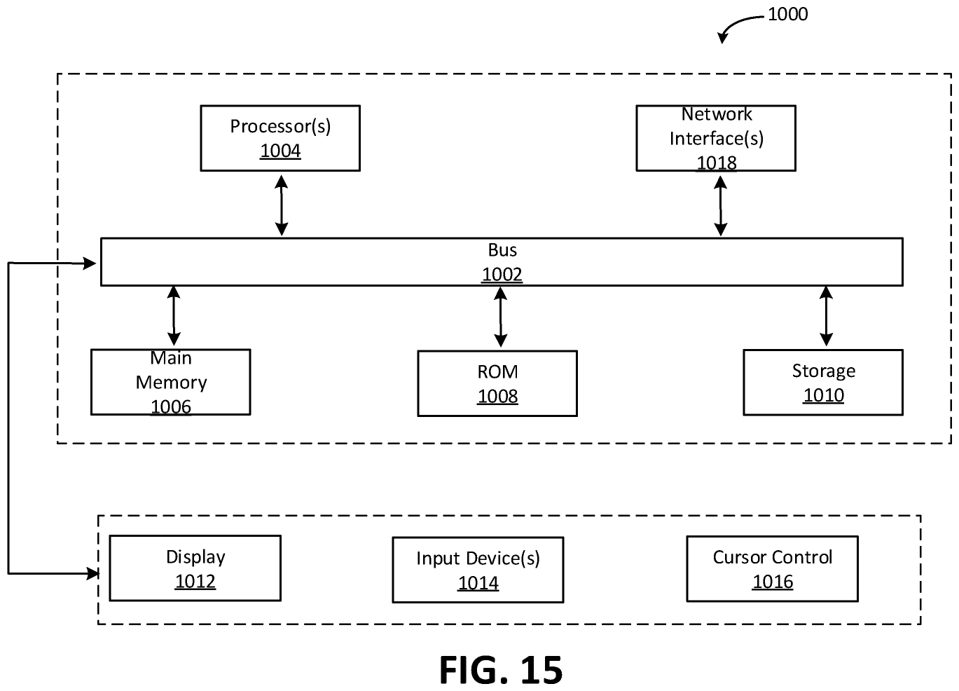

FIG. 15 depicts a block diagram of an example computer system 1000 in which various of the embodiments described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions. For enhanced security, in some embodiments storage at a UNode is embodied in ROM only.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some embodiments, the same direction information and command selections as cursor control may be implemented via receiving touches on a touch screen without a cursor.

The computing system 1000 may include a user interface component to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes a communication interface 1018 coupled to bus 1002. Network interface 1018 provides a two-way data communication coupling to one or more network links that are connected to one or more local networks. For example, communication interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or WAN component to communicated with a WAN). Wireless links may also be implemented. In any such implementation, network interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1018, which carry the digital data to and from computer system 1000, are example forms of transmission media.

The computer system 1000 can send messages and receive data, including program code, through the network(s), network link and communication interface 1018. In the Internet example, a server might transmit a requested code for an application program through the Internet, the ISP, the local network and the communication interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

As used herein, the term “node-independent blockchain” refers to a blockchain that is accessible to any node on a blockchain network, and where any node is eligible to participate in the consensus process. A “node-independent blockchain” may also be referred to herein as a “conventional blockchain.”

As used herein, the term “node-specific blockchain” refers to a blockchain maintained by an individual node that only includes blocks of transactions involving the network participant associated with the individual node. Only a subset of trusted nodes involved in a given transaction may participate in the consensus process for the addition of a subsequent block onto a node-specific blockchain. The right to view a node-specific blockchain maintained by a given node may be restricted to those trusted nodes that participate in a transaction with the given node. The right of such a trusted node to view a node-specific blockchain of the given node may further be restricted in time, based on the timing of a given transaction.

As used herein, the term “centralized identity” refers to a user profile of a trusted network participant that is maintained by a centralized node (e.g., the INode). The centralized identity is associated with a true identity of a network participant corresponding to a particular node (e.g., a particular UNode) within the blockchain networking environment of the present disclosure. The centralized identity may comprise any form of identifying information, such as a username, an email address, a code, etc.

As used herein, the terms “cryptocurrency” and “coin” are used interchangeably in the present disclosure, and generally refer to any tradable digital asset or digital form of currency that uses cryptography to verify and secure transactions. The transaction records embodied in the blockchain of the present disclosure can include transactions involving cryptocurrency.

As used herein, the term “hashing” is the process of taking an input and turning it into a cryptographic fixed output through a mathematical algorithm (e.g., Message Digest 5 (“MD5”), Secure Hash Algorithm (“SHA”)), for example). The output of the hashing process is referred to herein as a “hash,” and is the value returned by the mathematical algorithm based on the given input. An input can include a piece of information such as a message, a unit of data, or a cache of varying pieces of information such as a block of transactions. An input may be of an any size.

As used herein, the term “genesis block” refers to the first block of a blockchain. A genesis block can be generated by using an original set of transactions (and/or other information) which, when combined and provided as an input to a hashing process to produce a unique, original hash. Upon the occurrence of one or more new transactions (or at predetermined intervals), the original hash can be combined with the new transaction information, which can then be used as the new input to the hashing algorithm to create a brand new hash that is used to link the next block in the chain (creating a “blockchain”). Ultimately, each block in a blockchain links back to its previous block through its hash, forming a chain back to the original genesis block. For example, in embodiments of the technology of the present disclosure, transactions can be added securely as long as required nodes on the network are in consensus on what the hash should be pursuant to the Po2 Consensus Protocol.

For purposes of description the present disclosure has been explained in terms of two network participants transacting in a unique blockchain environment using, inter alia, a Proof-of-two (Po2) consensus protocol. It should be understood however that the examples provided herein should not be understood to limit the present disclosure to such embodiments. For instance, in implementations of the present technology that support transactions between more than two parties in a single transaction (e.g., a three party transaction, a five party transaction, an N-party transaction), the technology of the present disclosure may be modified to operate with a consensus protocol involving all of the participating parties (e.g., a proof-of-3 (Po3) protocol, a proof-of-5 (Po5) protocol, or, more generally, a proof-of-N (PoN) protocol where “N” represents the number of network participants that are parties to a given transaction.

Although various embodiments of the present disclosure are discussed herein in the context of blockchains, it should be understood that all such embodiments can be equally applied to distributed ledger technologies, or any modifications or variations thereon. For example, to the extent an embodiment is described in the context of a blockchain network, it should be appreciated that the embodiment may more generally be applied in a distributed ledger network.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for issuing token based loans in a blockchain supported network, the system comprising:
one or more processors; and
one or more memory devices storing instructions that, when executed by the one or more processors, cause the system to perform operations of:
receiving a loan request from a first network participant, the loan request including an amount of fiat-currency;
determining a number of tokens that correspond to the amount of fiat-currency, the determination based on a pre-determined exchange rate of fiat currency to tokens;
offering one or more loan products to the first network participant based on the loan request, the one or more loan products including loan terms comprising one or more of a fixed and/or a quasi-floating interest rate associated with the number of tokens,
wherein the quasi-floating interest rate is an interest rate applicable to one or more of the number of tokens based on an amount of time elapsed between a time the tokens are transferred to the first network participant and the time that one or more of (i) the tokens returned by the first network participant as repayment, (ii) the loan is paid off by the first network participant in fiat-cash, (iii) the tokens exchanged for fiat currency by either the first network participant or a direct or indirect payee of the first network participant;
receiving an indication of selection and acceptance of the terms of one of the one or more loan products by the network participant;
transferring the determined number of tokens to the first network participant in accordance with the loan product associated with the received indication, without transferring the fiat currency corresponding to the amount of fiat-currency to the first network participant.

2. The system of claim 1, wherein the one or more memory devices store instructions that, when executed by the one or more processors, further cause the system to perform operations of:
exchanging, in response to a request from a holder of one or more of the number of tokens, an amount of fiat currency for an amount of the one or more of the number of tokens at the predetermined exchange rate.

3. The system of claim 2, wherein the one or more memory devices store instructions that, when executed by the one or more processors, further cause the system to perform operations of:
determining the date of the exchange;
determining the date upon which a token of the number of tokens was transferred to the first network participant pursuant to the loan product associated with the received indication.
determining the quasi-floating interest rate applicable to the exchanged tokens based on the amount of time elapsed between the date of the exchange and the date upon which a token of the number of tokens was transferred to the first network participant.

4. The system of claim 3, wherein the one or more memory devices store instructions that, when executed by the one or more processors, further cause the system to perform operations of:
applying the quasi-floating interest rate to the number of tokens exchanged to determine a first interest accrual amount;
applying the first interest accrual amount to a principal amount associated with the loan product associated with the received indication.

5. The system of claim 3, wherein the quasi-floating interest rate decreases with increased time elapsed between a time the tokens are transferred to the first network participant and the time the tokens are exchanged for fiat currency.

6. The system of claim 3, wherein the quasi-floating interest rate becomes a negative interest rate if the time elapsed between a time the tokens are transferred to the first network participant and the time the tokens are exchanged for fiat currency exceeds a predetermined threshold.

7. The system of claim 3, wherein the quasi-floating interest rate changes during a term of the loan.

8. The system of claim 6, wherein the threshold is equivalent to the term of the loan product associated with the received indication.

9. The system of claim 6, wherein the threshold is greater than the term of the loan product associated with the received indication.

10. The system of claim 6, wherein the threshold is less than the term of the loan product associated with the received indication.

11. A method for generating token based loans in a blockchain supported network, the method comprising:
receiving a loan request from a first network participant, the loan request including an amount of fiat-currency;
determining a number of tokens that correspond to the amount of fiat-currency, the determination based on a pre-determined exchange rate of fiat currency to tokens;
offering one or more loan products to the first network participant based on the loan request, the one or more loan products including loan terms comprising one or more of a fixed and/or a quasi-floating interest rate associated with the number of tokens,
wherein the quasi-floating interest rate is an interest rate applicable to one or more of the number of tokens based on an amount of time elapsed between a time the tokens are transferred to the first network participant and the time that one or more of (i) the tokens returned by the first network participant as repayment, (ii) the loan is paid off by the first network participant in fiat-cash, (iii) the tokens exchanged for fiat currency by either the first network participant or a direct or indirect payee of the first network participant;
receiving an indication of selection and acceptance of the terms of one of the one or more loan products by the network participant;
transferring the determined number of tokens to the first network participant in accordance with the loan product associated with the received indication, without transferring the fiat currency corresponding to the amount of fiat-currency to the first network participant.

12. The method of claim 11, further comprising:
exchanging, in response to a request from a holder of one or more of the number of tokens, an amount of fiat currency for an amount of the one or more of the number of tokens at the predetermined exchange rate.

13. The method of claim 12, further comprising:
determining the date of the exchange;
determining the date upon which a token of the number of tokens was transferred to the first network participant pursuant to the loan product associated with the received indication.
determining the quasi-floating interest rate applicable to the exchanged tokens based on the amount of time elapsed between the date of the exchange and the date upon which a token of the number of tokens was transferred to the first network participant.

14. The method of claim 13, further comprising:
applying the quasi-floating interest rate to the number of tokens exchanged to determine a first interest accrual amount;
applying the first interest accrual amount to a principal amount associated with the loan product associated with the received indication.

15. The method of claim 13, wherein the quasi-floating interest rate decreases with increased time elapsed between a time the tokens are transferred to the first network participant and the time the tokens are exchanged for fiat currency.

16. The method of claim 13, wherein the quasi-floating interest rate becomes a negative interest rate if the time elapsed between a time the tokens are transferred to the first network participant and the time the tokens are exchanged for fiat currency exceeds a predetermined threshold.

17. The method of claim 13, wherein the quasi-floating interest rate changes during a term of the loan.

18. The method of claim 16, wherein the threshold is equivalent to the term of the loan product associated with the received indication.

19. The method of claim 16, wherein the threshold is greater than the term of the loan product associated with the received indication.

20. The method of claim 16, wherein the threshold is less than the term of the loan product associated with the received indication.
